(19) United States
(12) Patent Application Publication
(10) Pub. No.: US 2004/0195222 A1
(43) Pub. Date: Oct. 7, 2004

(54) Laser irradiation method, laser irradiation apparatus, and method for manufacturing semiconductor device

(75) Inventors: Koichiro Tanaka, Kanagawa (JP); Shunpei Yamazaki, Tokyo (JP)

Correspondence Address: NIXON PEABODY, LLP, 401 9TH STREET, NW, SUITE 900, WASHINGTON, DC, 20004-2128, US

(73) Assignee: Semiconductor Energy Laboratory Co., Ltd., Atsugi-shi (JP)

(21) Appl. No.: 10/744,100

(22) Filed: Dec. 24, 2003

(30) Foreign Application Priority Data
Dec. 25, 2002 (JP) 2002-375653

(51) Int. Cl. B23K 26/06

(52) U.S. Cl. 219/121.73

(57) ABSTRACT

In a process to manufacture a semiconductor device, when a CW laser beam is shaped into linear and is irradiated on a semiconductor film while scanning, a plurality of crystal grains extended long in the scanning direction are formed. The semiconductor thus formed has a characteristic similar to that of single-crystal substantially in the scanning direction. However, the output of a CW laser oscillator is so low that it takes much time to anneal and the design rule is also very restricted.

By operating a zoom function, a size of the linear laser beam can be changed in accordance with a size of a semiconductor element formed on a semiconductor element, the time required for laser annealing can be shortened, and the restriction of the design rule can be eased. The zoom function includes a zoom function that is continuously changeable (refer to FIG. 1A to 2C) and that can change the length of the linear laser beam into several pattern (refer to FIG. 6A, 6B, and 6C).

### BACKGROUND OF THE INVENTION

1. Field of the Invention

The present invention relates to a laser irradiation method and a laser irradiation apparatus utilizing the above method (the laser irradiation apparatus includes a laser oscillator and an optical system to guide a laser beam emitted from the laser oscillator to an object to be irradiated). Moreover, the present invention relates to a method for manufacturing a semiconductor device including the steps of crystallization, activation, heating or the like by the irradiation of the laser beam. It is noted that the semiconductor device includes an electro-optical device such as a liquid crystal display device, a light-emitting device and the like, and an electronic apparatus having the electro-optical device as its component.

2. Description of the Related Art

In recent years, the research has been conducted concerning the technology to crystallize an amorphous semiconductor film formed on an insulating substrate such as a glass substrate to form the semiconductor film with the crystalline structure (hereinafter referred to as crystalline semiconductor). As its crystallizing method, a thermal annealing method using an annealing furnace, a rapid thermal annealing method (RTA method), a laser annealing method or the like have been examined. When performing the crystallization, it is possible to employ one of these methods, or combine some of these methods.

The crystalline semiconductor film is superior to the amorphous semiconductor film in terms of its mobility. Therefore, the crystalline semiconductor film has been employed for a thin film transistor (hereinafter referred to as TFT) which is utilized for a liquid crystal display device of an active matrix type for example, having TFTs for pixel portions or both for pixel portions and driver circuits formed on one glass substrate.

Generally, in order to crystallize the amorphous semiconductor film in the annealing furnace, the heating process needs to be performed at a temperature of 600° C. for 10 hours or more. It is quartz that is suitable for a material of a substrate that is applicable for this crystallization, but a quartz substrate is expensive and is very difficult to be processed into a large substrate. Enlarging the size of the substrate is considered to be one of the means to increase production efficiency, and thereby the research has been conducted to form a semiconductor on a glass substrate which is inexpensive and can be easily processed into a large substrate. Recently, it has been examined to use the glass substrate with a side of 1 m or more.

As an example of the crystallization, the thermal crystallization method with metal element disclosed in the published patent application H7-183540 enables to lower the temperature of crystallization that has been a problem in the conventional method. According to the thermal crystallization method with metal element, the crystalline semiconductor film can be formed by adding a small amount of nickel, palladium, lead or the like to the amorphous semiconductor film and then heating it at a temperature of 550° C. for four hours. The temperature of 550° C. is lower than the distortion temperature of the glass substrate, and thereby it is not necessary to worry about its deformation and the like.

On the other hand, the laser annealing method enables to give high energy only to the semiconductor film without increasing the temperature of the substrate. Therefore, the laser annealing method is attracting attention because this method can be employed not only to the glass substrate whose distortion temperature is low, but also a plastic substrate and the like.

An example of the laser annealing method is explained as follows. A pulsed laser beam generated from an excimer laser is shaped into square with several centimeters on a side or linear with a length of 100 mm or more at a surface to be irradiated and the laser beam is moved relatively to the object to be irradiated to perform annealing. It is noted that “linear” here does not mean a line strictly but means a rectangle (an oblong or the like) with a large aspect ratio. For example, linear indicates a rectangle with an aspect ratio of two or more (preferably 10 to 10000), which is included in a laser beam that is rectangular in shape at the surface to be irradiated (rectangular laser beam). The laser beam is shaped into linear in order to secure energy density for sufficient annealing to the object to be irradiated, and the laser beam may have the rectangular shape or a planar shape provided that sufficient annealing can be performed to the object to be irradiated.

The crystalline semiconductor film thus manufactured has a plurality of crystal grains assembled and a position and a size of each crystal grain are random. TFT formed on the glass substrate is formed by patterning the crystalline semiconductor into island shape in order for isolation. In such a case, it was not possible to form the crystal grains as specifying their position and size. Compared to the inside of the crystal grain, the boundary between the crystal grains (crystal grain boundary) has an amorphous structure and an infinite number of recombination centers and trapping centers existing due to crystal defects. It is known that when a carrier is trapped in the trapping center, potential of the crystal grain boundary increases to become a barrier against the carrier, and therefore a current transporting characteristic of the carrier is lowered. Although the crystallinity of the semiconductor film in a channel forming region has a serious influence on characteristics of the TFT, it was almost impossible to form the channel forming region with a single-crystal semiconductor film by eliminating such-an influence of the crystal grain boundary.

Recently, attention has been paid to the technique of irradiating continuous wave (CW) laser beam to a semiconductor film while scanning with the CW laser beam in one direction to form a single-crystal grain extending long in the direction thereof. This technique is reported in the “Ultra-high Performance Poly-Si TFTs on a Glass by a Stable Scanning CW Laser Lateral Crystallization” by A. Hara, F. Takeuchi, M. Takei, K Yoshino, K. Suga and N. Sasaki, AMLCD '01 Tech. Dig.,2001,pp.227-230.

It is considered that it is possible, with this technique, to form a TFT that has almost no crystal grain boundary at least in a channel direction thereof.

However, in such a method, since the CW laser beam-has wavelengths that are absorbed sufficiently in the semiconductor film, only the laser oscillator that outputs as low as 10 W is utilized, and it is inferior to the excimer laser in terms of the productivity. It is noted that the CW laser oscillator with high output, having a wavelength of visible light or a shorter wavelength than that of visible light and having a very high stability is appropriate in this method. For example, a second harmonic of YVO₄ laser, a second harmonic of YAG laser, a second harmonic of YLF laser, a second harmonic of YalO₃ laser, Ar laser or the like is applicable as the laser oscillator However, when each of these lasers is applied for crystallization of the semiconductor film, the beam spot needs to be extremely narrowed in order to make up for the insufficient energy. Therefore, this leads to a problem in productivity, uniformity of the laser annealing and the like. In addition, in the ends of the beam spot which is extremely narrowed, there is formed poly-crystalline semiconductor film with many grain boundaries which have been often seen so far. Therefore, it is not preferable to form a device in such regions. It is the object of the present invention to solve such a problem.

### SUMMARY OF THE INVENTION

In the process to crystallize the semiconductor film with a CW laser beam, the technique to shape the beam spot into elongated (hereinafter referred to as linear) on a surface to be irradiated and scan it to the direction perpendicular to a major axis of the linear beam spot is generally employed in order to enhance productivity.

The shape of the elongated beam spot strongly depends on the shape of the laser beam emitted from a laser oscillator. For example, a solid laser having a circular rod emits a circular laser beam, and when it is extended long, it becomes elliptical. On the other hand, a solid laser having a slab rod emits a rectangular laser beam, and when it is extended long, it becomes rectangular. When the slab laser is used, the divergence angle in the direction of the longer side of a rectangular laser beam and that in the direction of the shorter side of it are different each other and thereby it is necessary to take it into consideration when designing the optical system. In the present invention, those beams are generically named as the linear beam. In addition, the linear laser beam indicates an elongated laser beam having a longer side which is ten times or more as long as a shorter side. Moreover, in the present invention, the laser beam having energy for e⁻² or more is defined as the linear laser beam when assuming that the maximum energy density of the linear laser beam is 1. It is noted that the length of the linear laser beam is described as a major axis, while its width is described as a minor axis in this specification.

The present invention provides a laser irradiation apparatus, a laser irradiation method and a method for manufacturing a semiconductor device, including an optical system which can change the length and the width of the linear laser beam, and an optical system which homogenizes the energy distribution of the linear laser beam in the direction of its major axis. With these optical systems, the length of the linear laser beam can be changed according to the size and the arrangement of the device so that the laser beam is irradiated in the necessary region effectively. Since the length of the laser beam is changeable, the present invention can be easily applied to the annealing of the devices with complicated circuits structure. In other words, by changing the length of the linear laser beam according to the width of the region where the annealing should be performed, the unnecessary annealing to the unnecessary regions can be minimized. As described above, in the both ends of the linear laser beam, there is formed, what is called, the poly-crystalline semiconductor film. Such a poly-crystalline semiconductor film is not appropriate to form the device that requires high characteristic. Therefore, it is very effective to be able to change the length of the linear laser beam because the regulation on the design rule can be eased. Moreover, in the present invention, by employing the optical system homogenizing the energy distribution of the linear laser beam in the direction of the major axis, the characteristic of the semiconductor film is made uniform, and thereby the performance of the semiconductor device can be enhanced. It is noted that the semiconductor device where the design rule is not so complicated does not require the zoom function, but in order to make the characteristic uniform after all, the linear laser beam with uniform energy distribution is necessary. It is preferable that the energy distribution varies within ±5% in the direction of the major axis of the linear laser beam. The present invention is recited as follows.

The present invention provides the laser irradiation method including the steps of changing a laser beam into a rectangular laser beam with uniform energy distribution through an optical system 1, shaping the rectangular laser beam into a linear laser beam with uniform energy distribution by having the rectangular laser beam form an image on a surface to be irradiated through an optical system having a zoom function 2, and changing a size of the linear laser beam on the surface to be irradiated by operating the zoom function appropriately.

The present invention provides the laser irradiation method including the steps of changing a laser beam into a rectangular laser beam with uniform energy distribution through a diffractive optics, shaping the rectangular laser beam into a linear laser beam with uniform energy distribution by having the rectangular laser beam form an image on a surface to be irradiated through an optical system having a zoom function, and changing a size of the linear laser beam on the surface to be irradiated by operating the zoom function appropriately.

The present invention provides the laser irradiation method including the steps of changing a laser beam into a rectangular laser beam with uniform energy distribution through an optical system 1, and shaping the rectangular laser beam into a linear laser beam with uniform energy distribution by having the rectangular laser beam form an image on a surface to be irradiated through an optical system having a finite conjugate design 2.

The present invention provides the laser irradiation method including the steps of changing a laser beam into a rectangular laser beam with uniform energy distribution through a diffractive optics, shaping the rectangular laser beam into a linear laser beam with uniform energy distribution by having the rectangular laser beam form an image on a surface to be irradiated through an optical system having a finite conjugate design.

The present invention provides the laser irradiation method including the steps of changing a laser beam into a rectangular laser beam with uniform energy distribution through an optical system 1, shaping the rectangular laser beam into a linear laser beam with uniform energy distribution by having the rectangular laser beam form an image on a surface to be irradiated through an optical system having a finite conjugate design 2, and changing a size of the linear laser beam by changing a ratio of the finite conjugate design.

The present invention provides the laser irradiation method including the steps of changing a laser beam into a rectangular laser beam with uniform energy distribution through a diffractive optics, shaping the rectangular laser beam into a linear laser beam with uniform energy distribution by having the rectangular laser beam form an image on a surface to be irradiated through an optical system having a finite conjugate design, and changing a size of the linear laser beam by changing a ratio of the finite conjugate design.

In the above structure, the laser oscillator is selected from a group consisting of a gas laser, a solid laser and a metal laser. As a gas laser, an Ar laser, a Kr laser, a CO₂ laser and the like are given. As a solid laser, a YAG laser, a YVO₄ laser, a YLF laser, a YAlO₃ laser, a Y₂O₃ laser, an alexandrite laser, a Ti: sapphire laser and the like are given. As a metal laser, a helium-cadmium laser and the like are given. The laser oscillator applied in the present invention is generally the CW laser oscillator, but a pulsed laser is also applicable provided that the time frame between pulses is extremely short, so that it can be taken as a continuous wave. In this case, in order to obtain such pulsed laser beams, it is possible to irradiate the laser beam at a high frequency of MHz or more, for example, within a range of 1 MHz to 1 GHz, preferably, within a range of 10 MHz to 100 MHz, or simultaneously irradiate such a pulsed laser beam together with a CW laser beam on the semiconductor film. In this case, it is possible to use a second harmonic of YVO₄ laser to obtain such a pulsed laser beam, for example.

In accordance with another aspect of the invention, the method of manufacturing a semiconductor device includes a step of irradiating a semiconductor film with a pulsed laser beam with such a high frequency as 1 MHz to 1 GHz, preferably, 10 MHz to 100 MHz, representatively, 80 MHz in order to crystallize the semiconductor film. Second harmonic of YVO4 laser may be used, for example.

In addition, in the above structure, the laser beam is converted into the second harmonic through non-linear optical element. When LBO, BBO, KDP, KTP, KB5, CLBO and the like are used as the crystal for the non-linear optical element, they are superior in terms of conversion efficiency. By setting the non-crystal optical element into the resonator of the laser oscillator, conversion efficiency is highly enhanced.

In addition, in the above structure, it is preferable that the laser beam is generated in TEM₀₀ mode because the uniformity of the energy distribution of the long beam can be enhanced.

The present invention provides a laser irradiation apparatus including a laser oscillator, an optical system 1 which changes a laser beam emitted from the laser oscillator into a rectangular laser beam with uniform energy distribution, and an optical system having a zoom function 2 which makes an image with the rectangular laser beam and changes a size of the laser beam on the surface to be irradiated.

The present invention provides the laser irradiation apparatus including a laser oscillator, a diffractive optics which changes a laser beam emitted from the laser oscillator into a rectangular laser beam with uniform energy distribution, and an optical system having a zoom function which forms an image with the rectangular laser beam and changes a size of the laser beam on the surface to be irradiated.

The present invention provides the laser irradiation apparatus including a laser oscillator, an optical system 1 which changes a laser beam emitted from the laser oscillator into rectangular with uniform energy distribution, and an optical system of a finite conjugate design 2 which forms an image with the rectangular laser beam.

The present invention provides the laser irradiation apparatus including a laser oscillator, a diffractive optics which changes a laser beam emitted from the laser oscillator into a rectangular laser beam with uniform energy distribution and an optical system with a finite conjugate design which forms an image with the rectangular laser beam.

The present invention provides the laser irradiation apparatus including a laser oscillator, an optical system 1 which changes a laser beam emitted from the laser oscillator into a rectangular laser beam with uniform energy distribution, and an optical system of a finite conjugate design 2 which forms an image with the rectangular laser beam and changes a size of the rectangular laser beam on the surface to be irradiated.

The present invention provides the laser irradiation apparatus including a laser oscillator, a diffractive optics which changes a laser beam emitted from the laser oscillator into a rectangular laser beam with uniform energy distribution, and an optical system of a finite conjugate design which forms an image with the rectangular laser beam and changes a size of the rectangular laser beam on the surface to be irradiated.

In the above structure, the laser oscillator is selected from the group consisting of a CW gas laser, solid laser and metal laser. As a gas laser, an Ar laser, a Kr laser, a CO₂ laser and the like are given. As a solid laser, a YAG laser, a YVO₄ laser, a YLF laser, a YAlO₃ laser, a Y₂O₃ laser, an alexandrite laser, a Ti: sapphire laser and the like are given. As a metal laser, a helium-cadmium laser and the like are given. The laser oscillator applied in the present invention is generally the CW laser oscillator, but a pulsed laser is also applicable provided that the time frame between pulses is extremely short so that it can be taken as a continuous wave. However, in order to obtain such pulsed laser beams, it is necessary to contrive ways to irradiate the laser beam, for example, the laser beam is irradiated with considerably high frequency for MHz or more or is irradiated with other CW laser beam at the same time on the semiconductor film, or the like.

The present invention provides a method for manufacturing a semiconductor device including the steps of, in case where a laser beam emitted from the laser oscillator is changed into a linear laser beam on a semiconductor film or its vicinity, changing a laser beam into a rectangular laser beam with the uniform energy distribution through an optical system 1, and then shaping the rectangular laser beam into a linear laser beam with uniform energy distribution by having the rectangular laser beam form an image on a surface to be irradiated through an optical system having a zoom function 2, changing a size of the linear laser beam on the surface to be irradiated in accordance with an arrangement of the semiconductor device by operating the zoom function appropriately, and forming the semiconductor element.

The present invention provides a method for manufacturing a semiconductor device including the steps of, in case where a laser beam emitted from the laser oscillator is changed into linear on a semiconductor film or its vicinity, changing a laser beam into a rectangular laser beam with uniform energy distribution through a diffractive optics, shaping the rectangular laser beam into a linear laser beam with uniform energy distribution by having the rectangular laser beam form an image on a surface to be irradiated through an optical system having a zoom function so as to form a linear laser beam with uniform energy distribution, changing a size of the linear laser beam on the surface to be irradiated in accordance with an arrangement of a semiconductor element by operating the zoom function appropriately, and forming the semiconductor element.

The present invention provides a method for manufacturing a semiconductor device including the steps of, in case where a laser beam emitted from the laser oscillator is changed into a linear laser beam on a semiconductor film or its vicinity, changing a laser beam into a rectangular laser beam with uniform energy distribution through an optical system 1, shaping the rectangular laser beam into a linear laser beam with uniform energy distribution by having the rectangular laser beam form an image on a surface to be irradiated through an optical system having a finite conjugate design 2, irradiating the linear laser beam on the semiconductor film, and forming the semiconductor element.

The present invention provides a method for manufacturing a semiconductor device including the steps of, in case where a laser beam emitted from the laser oscillator is changed into a linear laser beam on a semiconductor film or its vicinity, changing a laser beam into a rectangular laser beam with uniform energy distribution through a diffractive optics, shaping the rectangular laser beam into a linear laser beam with uniform energy distribution by having the rectangular laser beam form an image on a surface to be irradiated through an optical system having a finite conjugate design, and irradiating the linear laser beam on the semiconductor film, and forming the semiconductor element.

The present invention provides a method for manufacturing a semiconductor device including the steps of, in case where a laser beam emitted from the laser oscillator is changed into a linear laser beam on a semiconductor film or its vicinity, changing a laser beam into a rectangular laser beam with the uniform energy distribution through an optical system 1, shaping the rectangular laser beam into linear by having the laser beam form an image on a surface to be irradiated through an optical system of a finite conjugate design 2, changing the size of the linear laser beam on the surface to be irradiated is changed according to the arrangement of the semiconductor element by changing a ratio of the finite conjugate design, and forming the semiconductor element.

The present invention provides a method for manufacturing a semiconductor device including the steps of, in case where a laser beam emitted from the laser oscillator is changed into linear laser beam on a semiconductor film or its vicinity, changing a laser beam into a rectangular laser beam with the uniform energy distribution through a diffractive optics, shaping the rectangular laser beam into linear by having the laser beam form an image on a surface to be irradiated through an optical system of a finite conjugate design, changing the size of the linear laser beam on the surface to be irradiated according to the arrangement of the semiconductor element by changing the ratio of the finite conjugate design appropriately, and forming the semiconductor element.

In the above structure, the laser oscillator is selected from the group consisting of a CW gas laser, solid laser, and metal laser. As a gas laser, an Ar laser, a Kr laser, a CO₂ laser and the like are given. As a solid laser, a YAG laser, a YVO₄ laser, a YLF laser, a YAlO₃ laser, a Y₂O₃ laser, an alexandrite laser, a Ti: sapphire laser and the like are given. As a metal laser, a helium-cadmium laser and the like are given. The laser oscillator applied in the present invention is generally the CW laser oscillator, but a pulsed laser is also applicable provided that the time frame between pulses is extremely short, so that it can be taken as a continuous wave. However, in order to obtain such a pulsed laser beam, it is necessary to contrive ways to irradiate the laser beam, for example, the laser beam is irradiated with considerably high frequency for MHz or more, or is irradiated with other CW laser beam at the same time on the semiconductor film, or the like.

In addition, in the above structure, the laser beam is converted into the second harmonic through non-linear optical element. When LBO, BBO, KDP, KTP, KB5, CLBO and the like are used as the crystal for the non-linear optical element, they are superior in terms of conversion efficiency. By setting the non-linear optical element into the resonator of the laser oscillator, conversion efficiency is highly enhanced.

In the above structure, it is preferable that the laser beam is generated in TEM₀₀ mode, because it can enhance the uniformity of the energy distribution of the linear laser beam.

When the linear laser beam described above is irradiated on the semiconductor film, the semiconductor element whose characteristic is more uniform can be formed. In addition, the present invention is suitable to crystallize the semiconductor film, enhance crystallinity, and activate the impurities. Moreover, the present invention can adjust the length of the linear laser beam so that waste in processing can be avoided and throughput can be enhanced. In the semiconductor device such as a liquid crystal display device of an active matrix type applied the present invention, the operating characteristic and reliability of the semiconductor device can be enhanced. Furthermore, in the present invention, not only gas laser but also solid laser can be employed, and thereby it is possible to decrease the cost to manufacture the semiconductor device.

By employing the structure according to the present invention, basic significance shown down below can be obtained.

(a) More uniform annealing can be realized by irradiating the linear laser beam formed through the optical system in the present invention to the object to be irradiated. The present invention is effective especially in crystallizing the semiconductor film, enhancing its crystallinity, and activating the impurities.

(b) Since the length of the linear laser beam is changeable, the laser annealing can be performed in accordance with the design rule of the semiconductor element, and thereby the design rule can be eased.

(c) Since the length of the linear laser beam is changeable, the laser annealing can be performed in accordance with the design rule of the semiconductor element, and thereby throughput can be enhanced.

(d) Instead of the gas laser which is used in the conventional laser annealing method, the solid laser can be employed in the present invention, and thereby the cost for manufacturing the semiconductor device can be reduced.

(e) With these advantages satisfied, the enhancement of the operating characteristic and the reliability of the semiconductor device, typically a liquid crystal display device of active matrix type, can be realized. Moreover, the cost for manufacturing the semiconductor device can be reduced.

### BRIEF DESCRIPTION OF THE DRAWINGS

In the accompanying drawings:

FIG. 1A, 1B, and 1C are drawings to explain Embodiment Mode 1 of the present invention;

FIG. 2A, 2B and 2C are drawings to explain Embodiment Mode 1 of the present invention;

FIG. 3A, 3B and 3C are drawings to explain Embodiment Mode 1 of the present invention;

FIG. 4 is a drawing to explain Embodiment Mode 2 of the present invention;

FIG. 5 is a drawing to explain Embodiment Mode 4 of the present invention;

FIG. 6A, 6B, and 6C are drawings to explain Embodiment Mode 3 of the present invention;

FIG. 7A, 7B, and 7C are drawings to explain Embodiment Mode 3 of the present invention;

FIG. 8 is a drawing to explain Embodiment Mode 2;

FIG. 9 is a drawing to show that the linear laser beam is irradiated to the semiconductor film;

FIG. 10A, 10B, and 10C are sectional views to show processes to manufacture a pixel TFT and a driver circuit;

FIG. 11A, 11B, and 11C are sectional views to show processes to manufacture a pixel TFT and a driver circuit;

FIG. 12 is a sectional view to show processes to manufacture a pixel TFT and a driver circuit;

FIG. 13 is a top view to show the structure of a pixel TFT;

FIG. 14 is a sectional view of a driver circuit and a pixel portion in a pixel portion;

FIG. 15 is a sectional view of a structure of a driver circuit and a pixel portion in a light-emitting device;

FIG. 16A to 16F are drawings to show examples of semiconductor devices;

FIG. 17A to 17D are drawings to show examples of semiconductor devices; and

FIG. 18A, 18B and 18C are drawings to show examples of semiconductor devices.

### DETAILED DESCRIPTION OF THE PREFERRED EMBODIMENTS

### Embodiment Mode 1

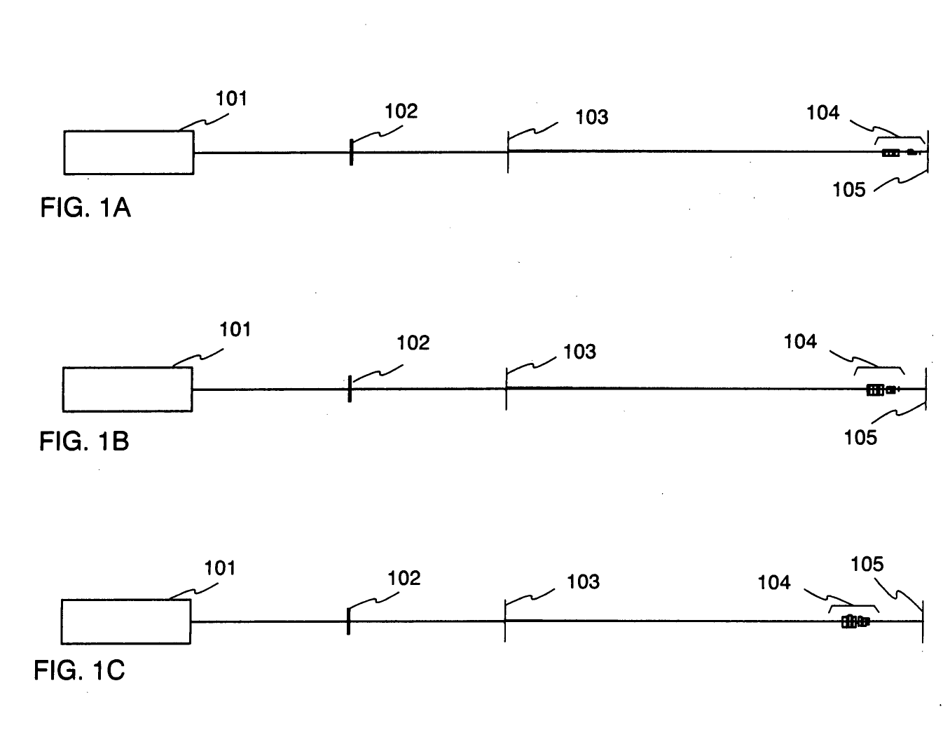

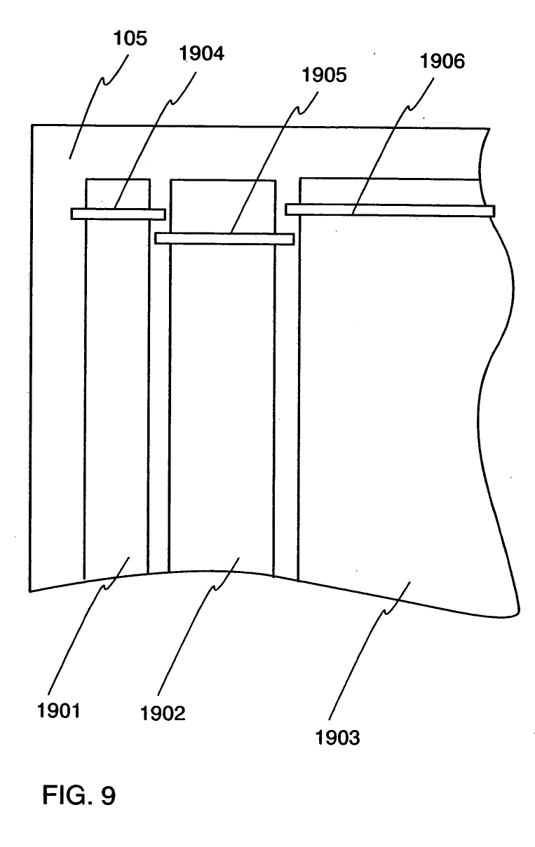

The Embodiment Mode 1 is explained with FIG. 1A to 3C, and FIG. 9. This embodiment mode explains an example of a linear laser beam whose size changes continuously on a surface to be irradiated.

In FIG. 1A, 1B, and 1C, a laser beam emitted from a laser oscillator 101 is changed into a rectangular laser beam with uniform energy distribution. An image 103 formed with the rectangular laser beam has a uniform energy distribution. For example, when a diffractive optics is used as an optical system 102, it is possible to form the laser beam whose energy distribution varies within ±5%. In order to obtain more uniform laser beam, the laser beam generated in the laser oscillator 101 must have a high quality. For example, the laser beam generated in TEM₀₀ mode could enhance its uniformity. Moreover, it is effective to employ the LD pumped laser oscillator because it can output stable energy and the uniformity of the laser annealing can be enhanced.

The image 103 whose energy distribution is homogenized by being shaped into rectangular through the optical system 102 is projected to a surface to be irradiated 105 through the optical system having a zoom function 104. As the optical system having a zoom function 104, the general zoom lens can be used. For example, a lens of a camera can be used as it is. However, it is necessary to coat the lens considering the intensity of the laser beam. The laser oscillator utilized in the present invention outputs several W to 100 W approximately and thereby it is necessary to coat the lens so as to resist the intensity of the laser beam. When the optical system having a zoom function is used, the optical path length may change. In such a case, the position of the surface to be irradiated 105 relative to the laser oscillator is changed or an optical system such as a mirror or the like is inserted in order to make up for its optical path length so that the image 103 is formed on the surface to be irradiated 105. FIG. 1A shows an example of the optical system which can reduce thirteen times from the size of the image 103. On the other hand, FIG. 1B shows an example of the optical system which can reduce seven times from the size of the image 103. FIG. 1C an example of the optical system which can reduce four times from the size of the image 103.

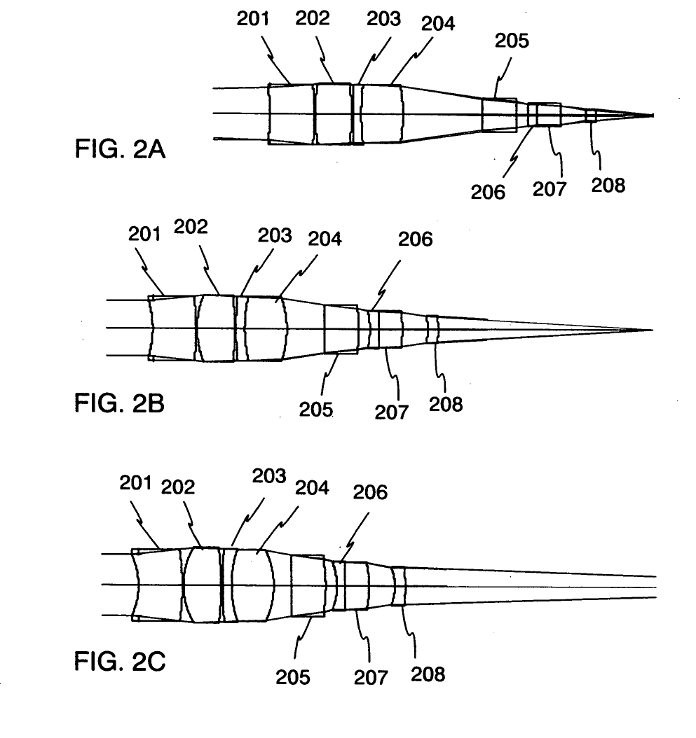

FIG. 2A, 2B, and 2C explain the optical system having a zoom function 104 in detail. The optical system 104 is what is input as a sample in the software for designing optical system named ZEMAX. And the example to change the shape of the laser beam through the optical system 104 is explained as follows.

First of all, the shape of the laser beam is changed into rectangular to form an image with uniform energy distribution 103 having a size of 4 mm×0.2 mm. For example, a CW solid laser oscillator that outputs 10 W of second harmonic (preferably a wavelength of green color or a shorter wavelength than that of green color) is used as a laser oscillator 101, and a diffractive optics may be used as an optical system 102. The reason why the laser oscillator having a wavelength of a green color or a shorter wavelength than that of a green color is employed preferably is that a longer wavelength than that of green color is hardly absorbed in a semiconductor film.

Next, the optical system 104 is arranged so that a first surface of a lens 201 included in the optical system 104 is arranged in the position 400 mm behind the image 103. Further details of the optical system 104 are explained as follows. The lens 201 is made of LAH66, having a first surface whose radius of curvature is −16.202203 mm, a second surface whose radius of curvature is −48.875855 mm, and a thickness of 5.18 mm. The sign is negative when the center of the curvature is on the side of a light source. On the other hand, the sign is positive when it is on the side opposite to the light source. The lens 202 is made of LLF6, having a first surface whose radius of curvature is 15.666614 mm, a second surface whose radius of curvature is −42.955326 mm and a thickness of 4.4 mm. The lens 203 is made of TIH6, having a first surface whose radius of curvature is 108.695652 mm, a second surface whose radius of curvature is 23.623907 mm, and a thickness of 1.0 mm. The lens 204 is made of FSL5, having a first surface whose radius of curvature is 23.623907 mm, a second surface whose radius of curvature is −16.059097 mm and a thickness of 4.96 mm. The lens 203 is bounded on the lens 204 and these lenses are not separated even in case to operate the zoom function. The lens 205 is made of FSL5, having a first surface whose radius of curvature is −425.531915 mm, a second surface whose radius of curvature is −35.435861 mm and a thickness of 4.04 mm. The lens 206 is made of LAL8, having a first surface whose radius of curvature is −14.146272 mm, a second surface whose radius of curvature is −251.256281 mm and a thickness of 1.0 mm. The lens 207 is made of PBH25, having a first surface whose radius of curvature is −251.256281 mm, a second surface whose radius of curvature is −22.502250 mm and a thickness of 2.8 mm. The lens 208 is made of LAH66, having a first surface whose radius of curvature is −10.583130 mm, a second surface whose radius of curvature is −44.444 444 mm and a thickness of 1.22 mm.

The zoom lenses shown in FIG. 2A, 2B, and 2C include an aspheric lens partially and thereby their aspheric coefficients are shown below. The second surface of the lens 202 is aspheric, whose aspheric coefficients are as follows. The 4th order term is 0.000104, the 6th order term is 1.4209E-7, the 8th order term is −8.8495E-9, the 10th order term is 1.2477E-10, the 12th order term is −1.0367E-12, and the 14th order term is 3.6556E-15. It is noted that the 2nd order term is 0.0. The second surface of the lens 204 is aspheric, whose aspheric coefficient are as follows. The 4th order term is 0.000043, the 6th order term is 1.2484E-7, the 8th order term is 9.7079E-9, the 10th order term is −1.8444E-10, the 12th order term is 1.8644E-12, and the 14th order term is −7.7975E-15. It is noted that the 2nd order term is 0.0. The first surface of the lens 205 is aspheric, whose aspheric coefficients are as follows. The 4th order term is 0.000113, the 6th order term is 4.8165E-7, the 8th order term is 1.8778E-8, the 10th order term is −5.7571E-10, the 12th order term is 8.9994E-12, and the 14th order term is −4.6768E-14. It is noted that the 2nd order term is 0.0.

Next, the way to change the size of the linear laser beam on the surface to be irradiated 105 through the optical system 104 is explained. The size of the linear laser beam can be changed in accordance with the general system of the zoom lens, and more specifically, zoom function is operated by changing an arrangement of the lens, the distance from the lens to the object, the distance from the lens to the image or the like.

Next, according to a lens arrangement described in FIG. 1A, or in FIG. 2A which is a detail view of the optical system 104, the size of the linear laser beam on the surface to be irradiated 105 becomes 0.3 mm×0.02 mm. In this case, the distance between each lens is as follows. The distance between the center of the lens 201 and that of the lens 202 is 0.1 mm. The distance between the center of the lens 202 and that of the lens 203 is 0.16 mm. The distance between the center of the lens 203 and that of the lens 204 is 0, because the lens 203 is bounded on the lens 204. The distance between the center of the lens 204 and that of the lens 205 is 9.48 mm. The distance between the center of the lens 205 and that of the lens 206 is 1.35 mm. The distance between the center of the lens 206 and that of the lens 207 is 0, because the lens 206 is bounded on the lens 207. The distance between the center of the lens 207 and that of the lens 208 is 3 mm. The distance between the center of the lens 208 and the surface to be irradiated 105 is 6.777292 mm.

According to a lens arrangement described in FIG. 1B, or in FIG. 2B which is a detail view of the optical system 104, the size of the linear laser beam on the surface to be irradiated 105 is 0.6 mm×0.03 mm. In this case, the distance between each lens is almost the same as that of FIG. 1A, and the different point is that the distance between the lens 204 and the lens 205 is 4.48 mm, and the distance between the lens 208 and the surface to be irradiated 105 is 28.548739 mm in FIG. 1B.

According to a lens arrangement described in FIG. 1C, or in FIG. 2C which is a detail view of the optical system 104, the size of the linear laser beam on the surface to be irradiated 105 is 1.0 mm×0.05 mm. In this case, the distance between each lens is almost the same as that of FIG. 1A, and the different point is that the distance between the lens 204 and the lens 205 is 2.0 mm, and the distance between the lens 208 and the surface to be irradiated 105 is 63.550823 mm in FIG. 1C.

An example of the lens data of the optical system was shown above. The essential figure may be the necessary digit number for the practitioner appropriately.

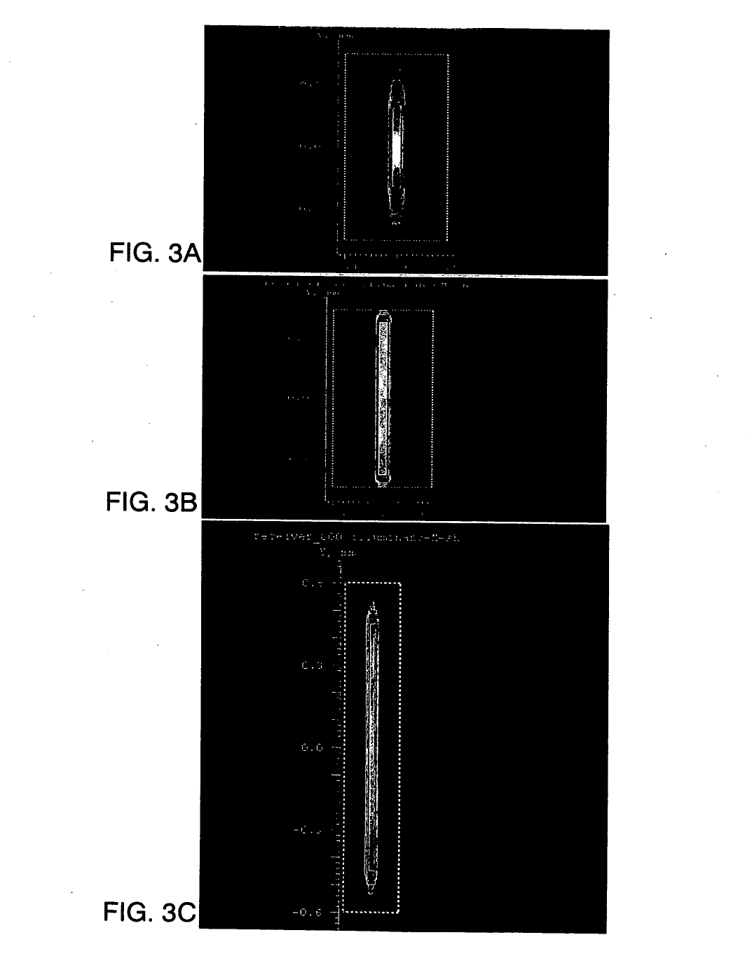

FIG. 3A, 3B, and 3C show the results of simulation for the linear laser beam on the surface to be irradiated 105 obtained through the optical system shown in FIG 1A, to 2C respectively. Vertical axis shows the direction of the major axis of the linear laser beam. On the other hand, horizontal axis shows the direction of the minor axis of the linear laser beam. The aspect ratio of the scale is modified so as to make it easier to understand the chart. As described above, it is clearly seen that the size of the laser beam is changed. The uniformity of the energy distribution of the linear laser beam is decreased due to the aberration of the zoom lens, but it is possible to obtain the laser beam whose energy density is more uniform by optimizing the zoom lens.

Next, an example of the method for manufacturing a semiconductor film which becomes an object to be irradiated is explained. First of all, a glass substrate is prepared. The glass substrate has a thickness of 1 mm approximately for example, and its size is determined by the practitioner appropriately. A silicon oxide film is formed about 200 nm in thickness on the glass substrate. And then an a-Si film is formed 66 nm in thickness on the silicon oxide film. After that, in order to increase the resistance against the laser beam, heating process is performed at a temperature of 500° C. for an hour in an atmosphere of nitrogen. With this heating process, the semiconductor film which becomes the object to be irradiated is formed. Instead of the heating process, the process to add the nickel element or the like in the semiconductor film to grow crystal based on the metal nucleus may be performed. Through this process, the enhancement of the reliability of the semiconductor element or the like can be expected. The details of the process are already explained in the description of the related art.

Next, an example of the laser oscillator 101 is explained. One of the optimum laser oscillators for the laser oscillator 101 is ILD pumped CW laser oscillator. Among such CW laser oscillators, a LD pumped CW laser oscillator which has a wavelength well absorbed in the semiconductor film is a YVO₄ laser of the second harmonic having a wavelength of 532 nm. When the laser oscillators which are available in the market is used, it is preferable to use the laser oscillator that outputs 10 W approximately and generate in TEM₀₀ mode. When the output exceeds 10 W, it may affect the uniformity of the energy distribution because the oscillation mode changes for the worse. However, since the size of the beam spot is extremely small, it is preferable to employ the laser oscillator with high output. But careful attention must be paid even in case employing the laser oscillators with high output, since there is possibility that the desired laser beam cannot be formed on the surface to be irradiated when the oscillation mode is not good.

Next, an example in which the linear laser beam is irradiated on the semiconductor film is explained with FIG. 9. The semiconductor film is arranged on the surface to be irradiated 105 shown in FIG. 1A, 1B, and 1C. The surface to be irradiated is mounted on the stage which can be operated in the two-dimensional plane including the surface to be irradiated 105. For example, the stage can be operated at a speed between 5 cm/s and 200 cm/s. When a liquid crystal display device having a driver integrated is manufactured, the linear laser beam with relatively high energy density is required in the region 1901 and 1902 corresponding to the driver circuits. Therefore, the linear laser beam having a size of that shown in FIG. 3A or 3B is employed to anneal the semiconductor film. That is to say, the linear laser beam 1904 or 1905 in FIG. 9 is employed. In this case, it is preferable that the short linear laser beam (FIG. 3A, for example) is employed in the region 1901 where the devices are arranged in the relatively narrow area, and the linear laser beam that is relatively long is employed in the region 1902 where the devices are arranged in the relatively large area. However, when the linear laser beam is made too long, the energy density falls to be very low, and as a result such energy density is no longer appropriate for the driver circuits that require high performance. Therefore, it is necessary to take the change of the energy density into consideration when changing the length of the linear laser beam. The energy density appropriate for the device with high performance is 0.01 MW/cm² to 1 MW/cm², but it changes depending on the condition of the semiconductor film, and thereby the practitioner needs to calculate the optimum value in each case. In FIG. 9, since the pixel region of the semiconductor element does not require the device operating at a high speed that much, the linear laser beam whose energy density is lowest (FIG. 3C) is employed to shorten the processing time. That is to say, in FIG. 9, a linear laser beam 1906 is used. As described above, the semiconductor film can be annealed very effectively by using the optical system with a zoom function. Since it is not meaningful to change the length of a width of the laser beam in the zoom function, an optical system which reacts in only one direction such as a cylindrical lens may be used for the zoom lens. However, a spherical lens gives higher accuracy than a cylindrical lens. It is a practitioner to decide which to choose. It is noted that the position of the linear laser beam on the semiconductor film is easily controlled by using a CCD camera in combination with an image processing system. In order to control its position with means above, there is a method to pattern a marker on the semiconductor film or a method to adjust the place to pattern in view of the laser irradiation track.

The linear laser beam shown in the present invention enables to perform more uniform laser annealing. Moreover, the present invention can be applied to crystallize the semiconductor film, improve crystallinity, and activate the impurities. Furthermore, it makes possible to ease the restriction of the design rule so as to enhance throughput by optimizing the length of the linear laser beam in accordance with the size of the device. And by crystallizing the semiconductor film with the laser beam with high uniformity, crystalline semiconductor film with high uniformity can be formed and the variation of the electrical characteristic of TFT can be reduced. In addition, in the semiconductor device, typically liquid crystal display device of an active matrix type applied the present invention, operating characteristic of the semiconductor device and the reliability can be enhanced. Furthermore, since solid laser, not gas laser utilized in the conventional laser annealing method, can be employed in the present invention, it becomes possible to decrease the cost required for manufacturing the semiconductor device.

### Embodiment Mode 2

This embodiment mode explains an example of an apparatus to synthesize the two of the laser beams to form a longer linear laser beam. Moreover, an example to anneal a semiconductor film with the above apparatus is explained.

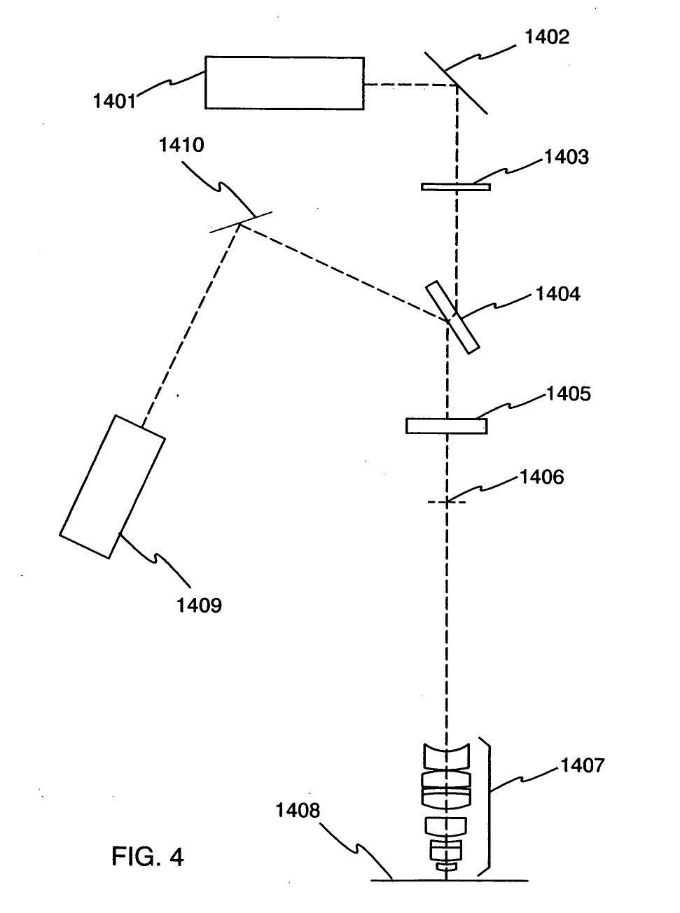

First of all, a method to form a long linear laser beam with two laser oscillators 1401 and 1409 both emitting linearly-polarized beams is explained with FIG. 4. The laser beam emitted from the laser oscillator 1401 is deflected by a mirror 1402, and its direction of polarization is rotated 90° by a ½λ wave plate 1403. The laser beam whose direction of polarization is rotated is arranged so as to transmit the TFP (thin Film Plate Polarizer) 1404 and is made incident into a diffractive optics 1405. Although TFP is used in this embodiment mode, any other optical elements having a similar function can be employed. And a rectangular beam spot with uniform energy distribution is formed at an image 1406. Moreover, the laser beam is made incident into an optical system having a zoom function 1407 to project the image 1406 to a surface to be irradiated 1408. On the other hand, the laser beam emitted from the laser oscillator 1409 is deflected by a mirror 1410 and is made incident into the TFP 1404 at a Brewster angle. This makes the laser beam reflected on the surface of the TFP 1404, and the laser beams emitted from the two laser oscillators are synthesized after outputting from the TFP 1404. The synthesized laser beam form a rectangular beam spot with uniform energy distribution at the image 1406 through the diffractive optics 1405. After that, the laser beam is made incident into the optical system having a zoom function 1407 to project the image 1406 to the surface to be irradiated 1408. Thus the laser beams emitted from the two laser oscillators are synthesized and projected on the surface to be irradiated 1408. Since the two of the laser beams are synthesized, the length of the linear laser beam is nearly doubled compared with that shown in the embodiment mode 1. For example, in the region where the high energy density is required, it is possible to apply the linear laser beam having a length of 1 mm approximately to form a device integrated with higher-density that can operate at a high speed.

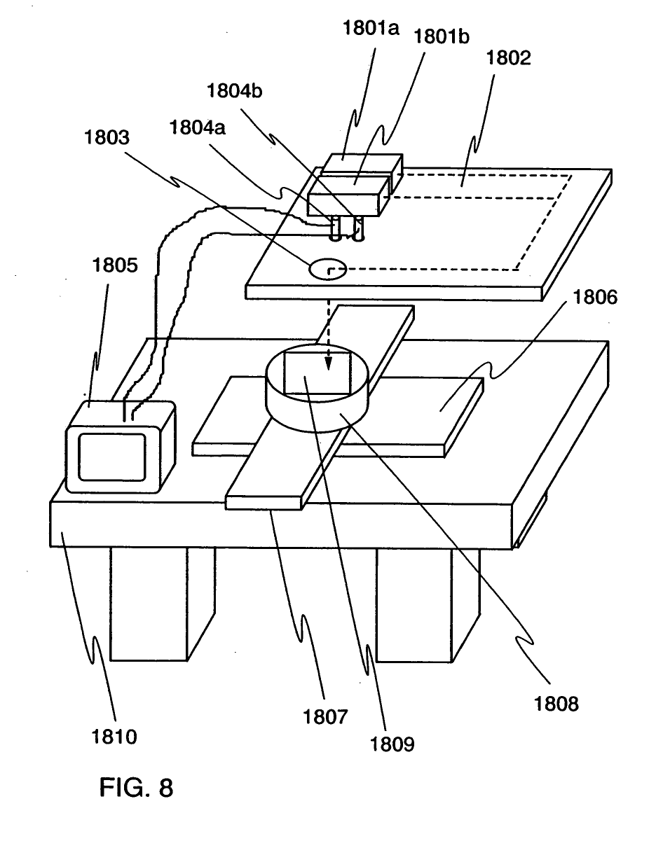

FIG. 8 shows a systemized laser irradiation apparatus. Two laser oscillators are used, and laser beams emitted from laser oscillators 1801a and 1801b are synthesized by the optical system that is not shown in FIG. 8. After that, the laser beam goes through an opening mouth 1803 provided in a plate 1802 to transmit the laser beam, and is irradiated on the semiconductor film 1809. Two laser oscillators, 1801a and 1801b, are arranged on the plate 1802 that has CCD cameras 1804a and 1804b to control the position of the semiconductor film installed on it. There are two CCD cameras arranged in the apparatus in order to enhance the accuracy to determine its position. The accuracy depends on its intended purpose, but normally requires several μm approximately. The display 1805 is to watch the image imported by the CCD cameras. The semiconductor film 1809 is rotated by rotating a stage 1808 based on the positional information obtained from this image processing system. With this rotation, the arranging direction of the semiconductor device and the scanning direction of the linear laser beam are corresponded. In this case, since the CCD cameras cannot moved freely, the positions are determined by operating the stage of X axis 1806 and the stage of Y axis 1807 at the same time.

After the positional information of the semiconductor film 1809 is clearly understood, the linear laser beam is irradiated on the desired position in the semiconductor film 1809. Here, the scanning speed is adjusted depending on the length of the linear laser beam (that is energy density) or required energy. For example, in the driver portion where the high-speed operation is required, the scanning speed between 5 cm/s and 100 cm/s is proper. On the other hand, in the pixel portion where the high-speed operation is not required that much, the scanning speed may be set between 50 cm/s and several m/s. As described above, the stages are operated at a relatively high speed, therefore it is preferable that this system is mounted on the vibration isolator table 1810. In some cases, active vibration isolator table is needed in order to reduce the vibration further. Or an air-floating non-contact linear motor may be applied to the stage of X axis 1806 and the stage of Y axis 1807 so as to suppress the vibration due to the friction of the bearings.

When the linear laser beam shown in the present invention is employed to irradiate the semiconductor film, the uniform laser annealing can be preformed. Moreover, the present invention is appropriate to crystallize the semiconductor film, enhance the crystallinity, and to activate the impurities. Furthermore, it makes possible to ease the restriction of the design rule so as to enhance throughput by optimizing the length of the linear laser beam in accordance with the size of the device. And by crystallizing the semiconductor film with the laser beam with high uniformity, crystalline semiconductor film with high uniformity can be formed and the variation of the electrical characteristic of TFT can be reduced. In addition, in the semiconductor device, typically liquid crystal display device of an active matrix type applying the present invention, operating characteristic of the semiconductor device and the reliability can be enhanced. Furthermore, since solid laser, not gas lasers utilized in the conventional laser annealing method, can be employed in the present invention, it becomes possible to decrease the cost required for manufacturing the semiconductor device.

### Embodiment Mode 3

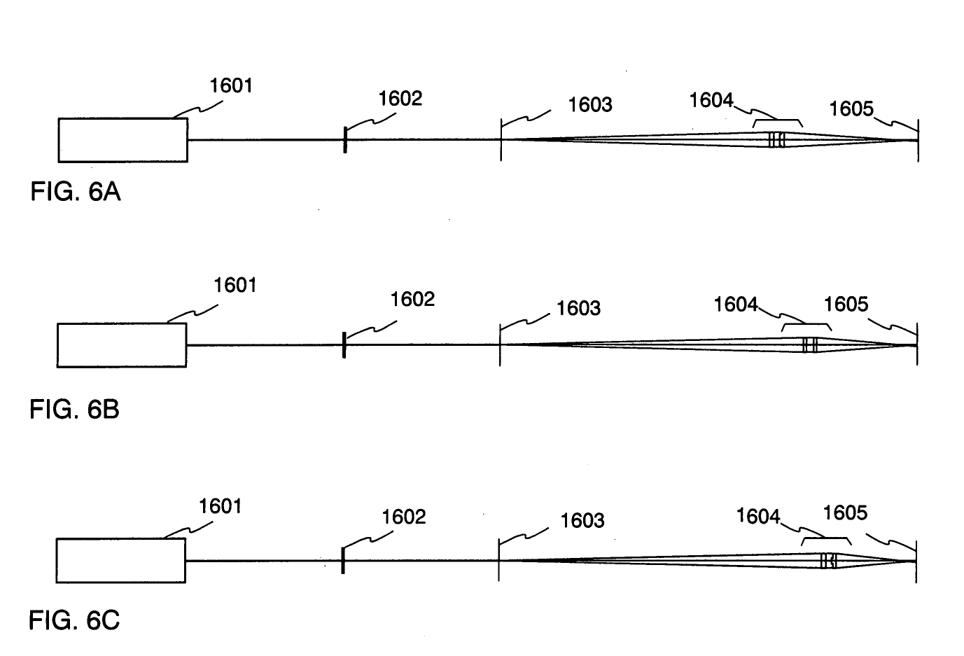

This embodiment mode explains an example of an optical system having a zoom function which is different from that described in the embodiment mode 1 with FIG. 6A, 6B, and 6C. The zoom function shown in this embodiment mode has a system in which the aberration is suppressed even though it is discontinuous system and thereby the uniform laser annealing can be performed.

In FIG. 6A, 6B, and 6C, a laser beam emitted from a laser oscillator 1601 is changed into a rectangular laser beam with uniform energy distribution through an optical system 1602. An image 1603 formed with the rectangular laser beam has very uniform energy distribution. For example, when a diffractive optics is employed as the optical system 1602, it is possible to form a-laser beam whose energy distribution varies within ±5%. In order to obtain the laser beam whose energy distribution is more uniform, it is important that the quality of the laser beam generated from the laser oscillator 1601 is high. Its uniformity can be enhanced by employing the laser beam generated in TEM₀₀ mode, for example. Moreover, it is effective to employ LD pumped laser oscillator because the output is kept stable in order to enhance the uniformity of the laser annealing.

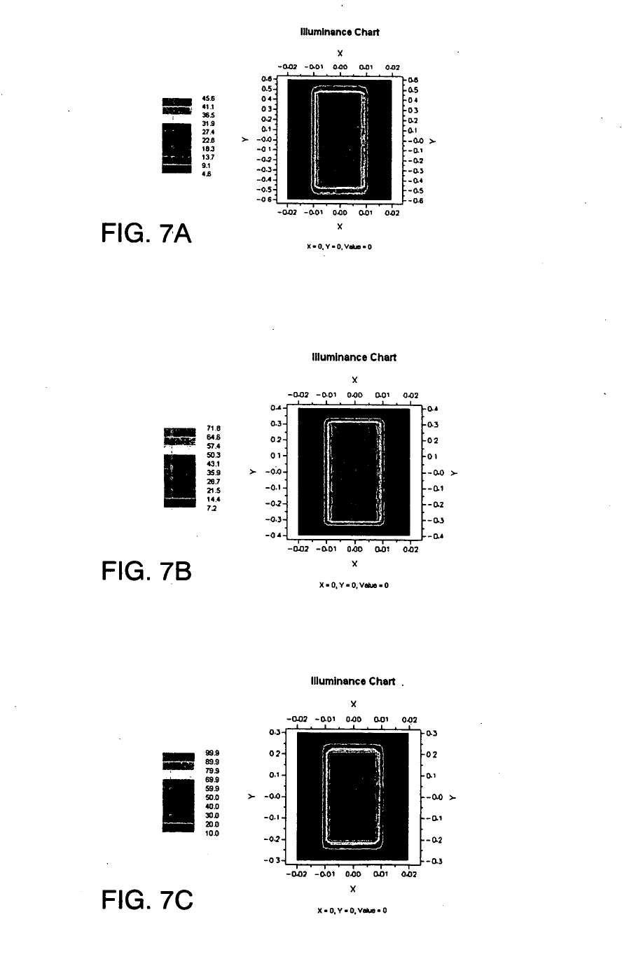

The image 1603 whose energy distribution is uniformed by the optical system 1602 is projected to an object to be irradiated 1605 after its size is changed through a relay system 1604a which is called a finite conjugate design. For example, in case of FIG. 6A, the conjugate ratio is 2:1, and thereby the rate of expansion of the image 1603 is one-half. Therefore, when the image 1603 has a size of 1 mm×0.02 mm, the size of the image on the surface to be irradiated 1605 is 0.5 mm×0.01 mm. When the linear laser beam is extended or reduced only in the direction of the major axis thereof, the relay system may include a cylindrical lens. FIG. 7A shows a result of a simulation by the software for designing an optical system when assuming the relay system includes the cylindrical lens. In the simulation, the size of the image 1603 is set to 1 mm×0.02 mm, and the cylindrical lens is arranged so as to make the length of the linear laser beam a half of it. The result indicates that the very uniform laser beam is obtained on the surface to be irradiated 1605. The optical system includes the lenses arranged in the positions that are explained as follows. A planoconvex cylindrical lens having a focal length of 400 mm is arranged in the position 400 mm behind the image 1603 so that the plane portion of the planoconvex cylindrical lens faces the image 1603. In the position 10 mm behind the convex portion of the planoconvex cylindrical lens, another planoconvex cylindrical lens having a focal length of 200 mm is arranged so that the plane portion faces the surface to be irradiated 1605. The surface to be irradiated 1605 is positioned 200 mm behind the plane portion thereof. Thus the relay system is constructed from the image 1603 to the surface to be irradiated 1605 having an optical path length of 600 mm approximately.

The size of the linear laser beam on the surface to be irradiated 1605 can be changed by replacing the relay system 1604a with a relay system 1604b. The conjugate ratio of the relay system 1604b is 3:1, and thereby the rate of expansion of the image 1603 is one-third. The way to replace the relay system may be determined by the practitioner appropriately, but it is preferable to rotate the system automatically by the revolver or the like. In order to keep the optical path length constant, the optical path length of the relay system 1604b is made same as that of the relay system 1604a For example, a planoconvex cylindrical lens having a focal length of 450 mm is arranged in the position 450 mm behind the image 1603 so that a plane portion of the cylindrical lens faces the image 1603. In the position 10 mm behind the convex portion of the planoconvex cylindrical lens, another planoconvex cylindrical lens having a focal length of 150 mm is arranged so that the plane portion faces the surface to be irradiated 1605. The surface to be irradiated 1605 is positioned 150 mm behind the plane portion thereof. Thus the relay system having an optical path length of 600 mm approximately is constructed from the image 1603 to the surface to be irradiated 1605.

In the same manner, a relay system 1604c having a conjugate ratio 4:1 is manufactured. For example, a planoconvex cylindrical lens having a focal length of 480 mm is arranged in the position 480 mm behind the image 1603 so that a plane portion of the cylindrical lens faces the image 1603. In the position 10 mm behind the convex portion of the planoconvex cylindrical lens, another planoconvex cylindrical lens having a focal length of 120 mm is arranged so that the plane portion faces the surface to be irradiated 1605. The surface to be irradiated 1605 is positioned 120 mm behind the plane portion thereof. Thus the relay system having an optical path length of 600 mm approximately is constructed from the image 1603 to the surface to be irradiated 1605.

The above structure seems inconvenient due to its inflexibility compared with the structure in which the length of the linear laser beam is changed continuously. However, in the actual process, the linear laser beam does not need to be processed into many kinds of lengths and it is enough to obtain several kinds of lengths. Therefore, even the optical system having several kinds of magnifications like a microscope can be applied in this process without any problems. In this embodiment mode, three kinds of linear laser beams having different lengths are described. When these linear laser beams are applied to the annealing of the semiconductor film shown in FIG. 9, it is possible to process the semiconductor film in the same manner as when using the optical system having a zoom function that can change the length of the linear laser beam. It is noted that when a semiconductor element has a simple design rule, only one kind of the length is enough for the linear laser beam of course. Even in such a case, very uniform annealing can be performed by employing such an optical system to anneal the semiconductor film. Therefore, the present invention is effective.

When the linear laser beam shown in the present invention is employed to irradiate the semiconductor film, the uniform laser annealing can be preformed. Moreover, the present invention is applicable to crystallize the semiconductor, enhance its crystallinity, and activate the impurities. In addition, it makes possible to ease the restriction of the design rule so as to enhance throughput by optimizing the length of the linear laser beam in accordance with the size of the device. And by crystallizing the semiconductor film with the laser beam with high uniformity, crystalline semiconductor film with high uniformity can be formed and the variation of the electrical characteristic of TFT can be decreased. In addition, in the semiconductor device, typically liquid crystal display device of an active matrix type manufactured with the present invention, operating characteristic of the semiconductor device and the reliability can be enhanced. Furthermore, since solid laser, not gas lasers utilized in the conventional laser annealing method, can be employed in the present invention, it becomes possible to decrease the cost required for manufacturing the semiconductor device.

### Embodiment Mode 4

The embodiment modes so far showed the examples to utilize one laser oscillator or two laser oscillators. This embodiment mode explains an example where three or more laser oscillators are utilized.

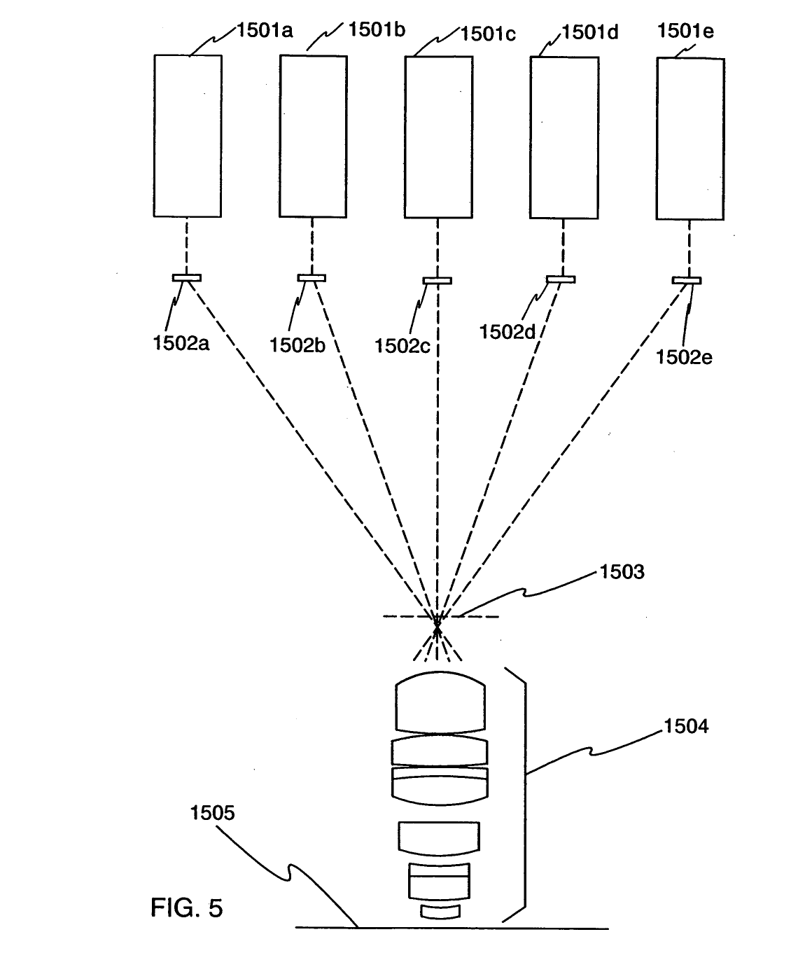

FIG. 5 shows an example in which five laser oscillators are used. Laser beams emitted from laser oscillators 1501a to 1501e are incident into optical systems 1502a to 1502e respectively and are changed into rectangular with uniform energy distribution on a plane 1503. Since the direction to which the laser beams travel depends on the positions of the laser oscillators, the emitted laser beams are headed to the plane 1503 from the different directions respectively in FIG. 5. Therefore, the directions of the laser beams emitted from the optical systems 1502a to 1502e should be differed in order to synthesize these laser beams on the plane 1503. The diffractive optics is given as an example of an optical system that enables such a thing. Through the optical system 1502a to 1502e, the laser beams emitted from the five laser oscillators are converted into the large laser beam with uniform energy distribution on the plane 1503. The image formed by the laser beam on the plane 1503 is translated to the surface to be irradiated 1505 through the optical system having a zoom function 1504. Thus the linear laser beam having a length for five of the laser beams can be formed. The length is, for example, assumed to be between 2 mm and 5 mm when each laser oscillator outputs 10 W. When a semiconductor film having a width of 5 mm is crystallized once, a driver circuit that drives a liquid crystal display device can be included as a whole in the crystallized region and thereby this device turns into a very useful device.

When the linear laser beam shown in the present invention is employed to irradiate the semiconductor film, the uniform laser annealing can be preformed. Moreover, the present invention is applicable to crystallize the semiconductor, enhance its crystallinity, and activate the impurities. In addition, it makes possible to ease the restriction of the design rule to enhance throughput by optimizing the length of the linear laser beam in accordance with the size of the device. And by crystallizing the semiconductor film with the laser beam with high uniformity, crystalline semiconductor film with high uniformity can be formed and the variation of the electrical characteristic of TFT can be reduced. In addition, in the semiconductor device, typically liquid crystal display device of an active matrix type manufactured with applying the present invention, operating characteristic of the semiconductor device and the reliability can be enhanced. Furthermore, since solid laser, not gas lasers utilized in the conventional laser annealing method, can be employed in the present invention, it becomes possible to decrease the cost required for manufacturing the semiconductor device.

### Embodiment 1

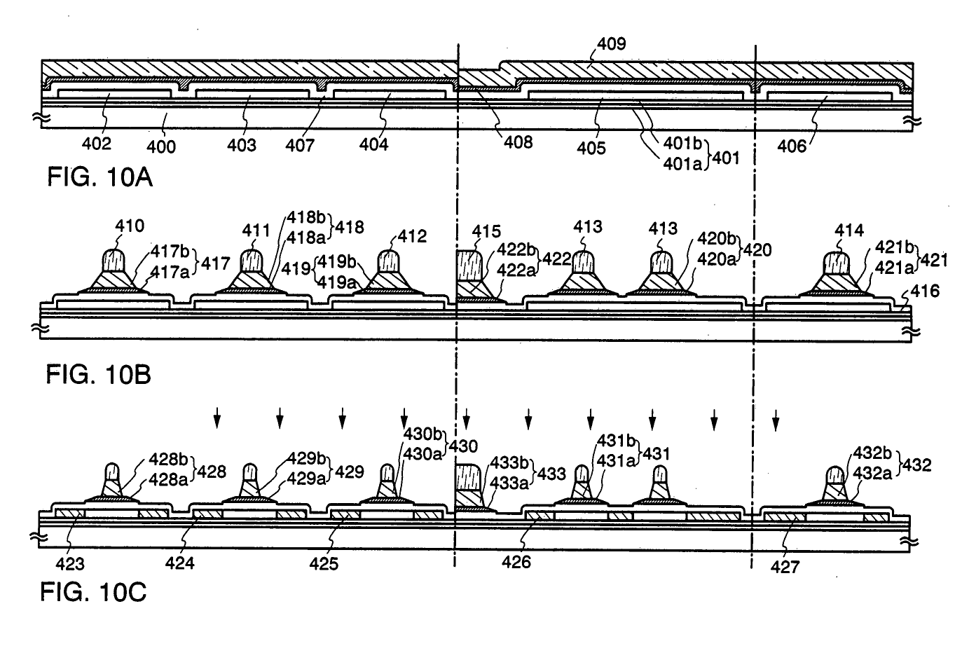

This embodiment explains a method for manufacturing an active matrix substrate using FIG. 10A to 13. In this specification, a substrate in which a CMOS circuit, a driver circuit, a pixel TFT, and a retention volume are integrated on the same substrate is called an active matrix substrate for convenience.

First of all, a substrate 400 including a glass such as a barium borosilicate glass, aluminoborosilicate glass or the like is prepared. It is noted that a quartz substrate, a silicon substrate, a metal substrate, or a stainless substrate on which an insulating film is formed can be also used as the substrate 400. Moreover, a plastic substrate that can resist against the heat generated in the processes in this embodiment can be used, and so can a flexible substrate. It is noted that a linear laser beam with uniform distribution can be easily formed according to the present invention, and thereby it is possible to anneal a large substrate effectively with a plurality of laser beams employed.

Next, a base film 401 formed of an insulating film such as a silicon oxide film, a silicon nitride film, a silicon oxynitride film or the like is formed on a substrate 400 by a known method. In this embodiment, the base film 401 is formed in a two-layers structure, but it may be formed in a single-layer structure or in a laminated-layer structure of more than two layers.

Next, a semiconductor film is formed on the base film. The semiconductor film is formed 25 nm to 200 nm (preferably 30 nm to 150 nm) in thickness by the known method (such as a sputtering method, LPCVD method, plasma CVD method or the like), and is crystallized by a laser crystallization method. With the laser crystallization method shown in the embodiment mode 1 or 2, or the method in which these are combined, the laser beam is irradiated to the semiconductor film. The laser oscillator employed in this embodiment is preferably a solid laser, a gas laser or a metal laser, which generates a CW laser beam. As the solid laser, a YAG laser, a YVO₄ laser, a YLF laser, a YalO₃ laser, a Y₂O₃ laser, an alexandrite laser, a Ti: Sapphire laser and the like are given. As the gas laser, an Ar laser, a Kr laser, a CO₂ laser, and the like are given. As the metal laser, a helium-cadmium laser and the like are given. In addition, not only a CW laser oscillator, but also a pulsed laser oscillator can be used in this embodiment. If a CW excimer laser can be put into a practical use, it can be also employed in the invention. Of course, not only laser annealing method, but also a combination with other known crystallization methods (such as RTA, thermal crystallization method, thermal crystallization method using a metal element to promote crystallization or the like) may be employed. As the semiconductor film, an amorphous semiconductor film, microcrystalline semiconductor film, crystalline semiconductor film or the like is given. A chemical compound semiconductor film having an amorphous structure such as an amorphous silicon germanium film, an amorphous silicon carbide film or the like may be applied.

In this embodiment mode, the plasma CVD method is employed to form the amorphous silicon film 50 nm in thickness, and the thermal crystallization method adding the metal element to promote crystallization to the amorphous silicon film and the laser annealing method are performed. Nickel is used as the metal element, and after adding the nickel to the amorphous silicon film with a spin coating method, a heating process is performed at a temperature of 550° C. for five hours to obtain a first crystalline silicon film. And after a laser beam emitted from a CW YVO₄ laser that outputs 10 W is converted into the second harmonic through a non-linear optical element, a laser annealing is performed with the method shown in the embodiment mode 1 to 4, or the methods combining any of those to obtain a second crystalline silicon film. Here, by utilizing the image processing system shown in FIG. 8, the semiconductor film can be annealed in accordance with the design rule of the TFT formed on the semiconductor film. Therefore, the semiconductor is annealed effectively by changing the length of the linear laser beam according to the design rule. In the region where the TFT with particularly high characteristic is formed, the laser beam whose energy density is high (that is to say, the length of the linear laser beam is relatively shortened) is irradiated in order to form large-size grain crystals. On the other hand, in the region where the TFT that does not require such a high characteristic is formed, the laser beam whose energy density is low (that is, the linear laser beam is extended relatively long) is irradiated. As for the specific conditions of laser irradiation, please refer to the following description. By irradiating a laser beam to the first crystalline silicon film in order to form the second crystalline silicon film, the crystallinity is enhanced. The energy density here is necessary for 0.01 MW/cm²to 100 MW/cm² (preferably between 0.1 MW/cm² and 10 MW/cm²). And the laser beam is irradiated to form the second crystalline silicon film by moving the stage relatively to the laser beam at a speed of 0.5 cm/s to 2000 cm/s.

Of course, TFT can be formed with the first crystalline silicon film, but since the second crystalline silicon film has enhanced crystallinity, it is preferable to employ the second crystalline silicon film for the TFT so as to improve its electrical characteristic.

The crystalline semiconductor film thus obtained is patterned with the photolithography method to form semiconductor layers 402 to 406.

In addition, after forming the semiconductor layers 402 to 406, a small amount of impurities (boron or phosphorus) may be doped in order to control the threshold of TFT.

Next, a gate insulating film 407 is formed to cover the semiconductor layers 402 to 406. The gate insulating film 407 is formed of an insulating film including silicon in 40 nm to 150 nm thick with the plasma CVD method or the sputtering method. In this embodiment, a silicon oxynitride film is formed 110 nm in thickness with the plasma CVD method. Of course, the gate insulating film may be formed of another insulating film instead of the silicon oxynitride film in a single-layer structure or in a laminated-layer structure.

Next, a first conductive film 408 having a thickness of 20 nm to 100 nm and a second conductive film 409 having a thickness of 100 nm to 40 nm are formed in a laminated structure on the gate insulating film 407. In this embodiment, the first conductive film 408 including TaN film having a thickness of 30 nm, and the second conductive film 409 including W film having a thickness of 370 nm are formed in a laminated structure. The TaN film is formed with the sputtering method, using Ta as a target in the atmosphere of nitrogen. And the W film is formed with the sputtering method, using W as a target. Instead of the sputtering method, the W film can be also formed with a thermal CVD method using tungsten hexafluoride (WF6). In any way, in order to use it as a gate electrode, it is necessary to make it low resistant, and thereby the resistivity of the W film is made not more than 20 μΩcm.

It is noted that in this embodiment the first conductive film 408 is formed of TaN, the second conductive film 409 is formed of W, but it is not limited to these elements. Both of the conductive films may be formed of the elements selected from the group consisting of Ta, W, Ti, Mo, Al; Cu, Cr and Nd, or of a chemical compound material or an alloy material including the above element as its main component. In addition, the semiconductor film, typically a poly-crystalline silicon film, including the impurities such as phosphorus may be employed. Moreover, AgPdCu alloy can be used, too.

Next, the photolithography method is employed to form masks 410 to 415 made from resist, and a first etching process is performed to form electrodes and wirings. The first etching process is performed in accordance with first and second etching conditions (FIG. 10B). An ICP (Inductively Coupled Plasma) etching method is employed as the first etching condition in this embodiment. The etching process is performed under the first etching condition in which CF₄, Cl₂ and O₂ are used as the etching gas at a gas flow rate 25:25:10 (sccm) respectively, and plasma is generated by applying 500 W RF (13.56 MHz) electric power to a coil shaped electrode at a pressure of 1.0 Pa. 150 W RF (13.56 MHz) electric power is also applied to the substrate side (sample stage), and thereby substantially a negative self-bias voltage is impressed. The W film is etched under the first etching condition, and the edge portions of the first conductive film are made into a tapered shape.

Next, the etching process is performed under the second etching condition without removing the masks made from resist 410 to 415. In the second etching condition, CF₄ and Cl₂ are used as an etching gas at a gas flow rate 30:30 (sccm) and plasma is generated by applying 500 W RF (13.56 MHz) to a coil shaped electrode at a pressure of 1.0 Pa. Then the etching process is performed for about 30 seconds. 20 W RF (13.56 MHz) electric power is also applied to the substrate side (sample stage), and thereby substantially a negative self-bias voltage is impressed. Under the second etching condition using the mixed gas of CF₄ and Cl₂, the W film and the TaN film are both etched to the same extent. It is noted that in order to perform the etching process without leaving a residue on the gate insulating film, the time for etching is increased by 10% to 20%.

In the first etching process described above, the end portions of the first and second conductive layers are made into tapered shape due to the bias voltage impressed to the substrate side by optimizing the shape of the masks made from resist. And the angle of the tapered portions becomes 15° to 45°. Thus first shaped conductive layers 417 to 422 (the first conductive layers 417a to 422a and the second conductive layers 417b to 422b) including the first conductive layer and the second conductive layer are formed. A reference number 416 is a gate insulating film and the region not covered with the first shaped conductive film 417 to 422 is etched for 20 nm to 50 nm.

Next, a second etching process is performed without removing the masks made from resist (FIG. 10C). The second etching process is performed under the condition in which CF₄, Cl₂ and O₂ are used as etching gas to etch the W film selectively. Through the second etching process, the second conductive layers 428b to 433b are formed. On the other hand, the first conductive layers 417a to 422a are hardly etched, and thereby a second shaped conductive layers 428 to 433 are formed.

Then a first doping process is performed without removing the masks made from resist. The impurity element which imparts n-type is doped in the crystalline semiconductor layer at a low concentration through this process. The first doping process may be performed by an ion doping method or an ion implantation method. The Ion doping process is performed under the condition in which the dosage is set from 1×10¹³ ions/cm² to 5×10¹⁴ ionS/cm², and the acceleration voltage is set from 40 keV to 80 keV. In this embodiment, the dosage is set to 1.5×10¹³ ions/cm² and the acceleration voltage is set to 60 keV. A 15th element in the periodic table, typically phosphorus (P) or arsenic (As) is used as an impurity element which imparts n-type. Phosphorus (P) is used in this embodiment. Then impurity regions 423 to 427 are formed in a self-aligning manner by using the conductive layers 428 to 433 as the masks against the impurities that impart n-type. The impurities that impart n-type are doped in the impurity regions 423 to 427 at a concentration between 1×10¹⁸ atoms/cm³ and 1×10²⁰ atoms/cm³.

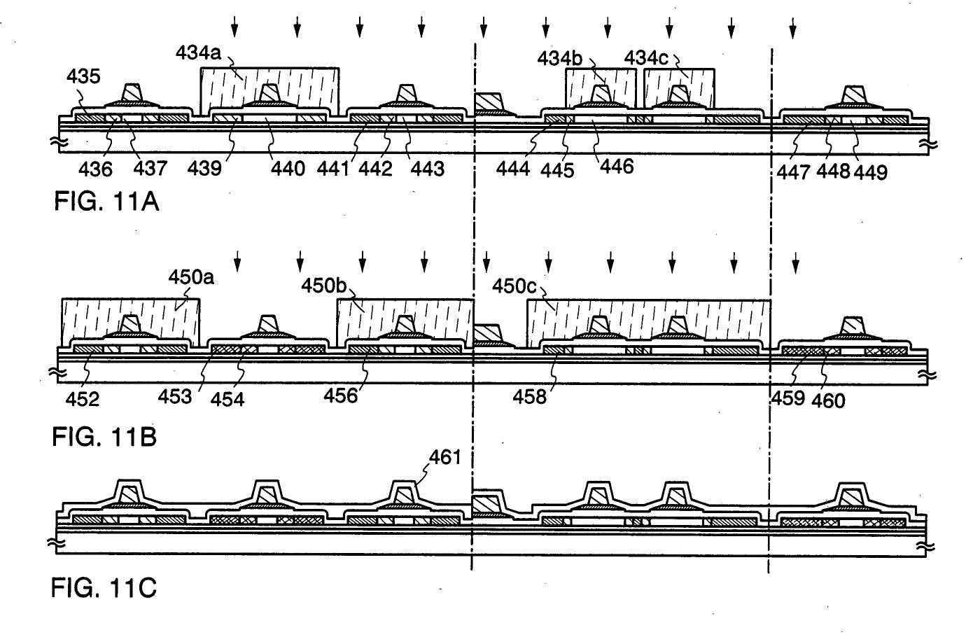

Next, the masks made from resist are removed. Then the masks made from resist 434a to 434c are newly formed, and a second doping process is performed at the higher acceleration voltage than that in the first doping process. Ion doping is performed under the conditions in which the dosage is set between 1×10¹³ ions/cm² and 1×10¹⁵ ions/cm² , and the acceleration voltage is set between 60 keV and 120 keV. The second conductive layers 428b to 432b are used as masks against the impurity element through the second doping process and the doping process is performed so that the impurity element is doped also in the semiconductor layer provided below the tapered portion of the first conductive layer. Next, a third doping process is performed at the lower acceleration voltage than that in the second doping process to obtain the state of FIG. 11A. Ion doping is performed under the conditions in which the dosage is set between 1×10¹⁵ ions/cm² and 1×10¹⁷ ions/cm², and the acceleration voltage is set between 50 keV and 100 keV. Through the second and the third doping processes, the low-concentrated impurity regions 436, 442 and 448, overlapped with the first conductive layer are doped impurities that impart n-type at a concentration between 1×10¹⁸ atoms/cm³ and 5×10¹⁹ atoms/cm³. On the other hand, the high-concentrated impurity regions 435, 438, 441, 444 and 447 are doped impurities that impart n-type at a concentration between 1×10¹⁹ atoms/cm³ and 5×10²¹ atoms/cm³.

Of course, it is possible to form both of the low-concentrated and the high concentrated impurity regions by performing the doping process only once instead of performing the second and the third doping processes by adjusting the accelerating voltage appropriately.

Next, after removing the masks made from resist, new masks 450a to 450b are formed and a fourth doping process is performed. Through the fourth doping process, the semiconductor layer which turns into an active layer of p-channel type TFT is doped impurities that impart the conductivity type opposite to the former one and thus impurity regions 453 to 456, 459 and 460 are formed. The second conductive layers 428a to 432a are used as masks against the impurities and an impurity region is formed in a self-aligning manner by doping the impurities that impart p-type. In this embodiment, the impurity regions 453 to 456, 459 and 460 are formed by the ion doping method with diborane (B₂H₆) (FIG. 11B). During the fourth doping process, the semiconductor layer forming the n-channel TFT is covered by the masks 450a to 450c. Although phosphorus is doped to the impurity regions 438 and 439 at a different concentration respectively through the first to the third doping processes, doping processes are performed so that the concentration of the impurities that impart p-type may be between 1×10¹⁹ atoms/cm³ and 5×10²¹ atoms/cm³ in both regions, and thereby these regions work as the source region and the drain regions of p-channel TFT without any problems.

With these processes, the impurity regions are formed on the semiconductor layers.

Next, after removing the masks 450a to 450c made from resist, a first interlayer insulating film 461 is formed. The first interlayer insulating film 461 is formed of the insulating film including silicon in 100 nm to 200 nm thick with the plasma CVD method or the sputtering method. In this embodiment, a silicon oxynitride film is formed 150 nm in thickness with the plasma CVD method. Of course, a material for the first interlayer insulating film 461 is not limited to silicon oxynitride, and another insulating film including silicon may be employed in a single-layer structure or a laminated-layer structure.

Next, a recovery of the crystallinity in the semiconductor layer and an activation of the impurities doped in each semiconductor layer are performed by irradiating the laser beam, for example. As for the activation with the laser irradiation, a method among the embodiment modes 1 to 4, or a method combining any of those is employed to irradiate the laser beam to the semiconductor film. Concerning the laser oscillator, a CW solid laser, gas laser or metal laser is preferable. As the solid laser, a CW YAG laser, YVO₄ laser, YLF laser, YalO₃ laser, Y₂O₃ laser, alexandrite laser, Ti: Sapphire laser and the like are given. As the gas laser, Ar laser, Kr laser, CO₂ laser, and the like are given. And as the metal laser, a CW helium-cadmium laser and the like are given. In addition, not only a CW laser oscillator, but also a pulsed laser oscillator can be used in this embodiment. If a CW excimer laser can be put into a practical use, it is also applicable in the present invention. In case of using a CW laser oscillator, the energy density is required for 0.01 MW/cm² to 100 MW/cm² (preferably between 0.1 MW/cm² and 10 MW/cm²). The substrate is moved relatively to the laser beam at a speed of 0.5 cm/s to 2000 cm/s. In addition, in case of the activation, a pulsed laser oscillator can be used, but it is preferable that a frequency is not less than 300 Hz and the energy density of the laser beam is between 50 mJ/cm² and 1000 mJ/cm² (typically 50 mJ/cm² and 500 mJ/cm²). In this case, the laser beam may be overlapped for 50% to 98%. It is noted that instead of laser annealing method, thermal annealing method, rapid thermal annealing method (RTA method) or the like can be applied.

In addition, the activation may be performed before forming the first interlayer insulating film. However, when the wiring material does not have enough resistance against the heat, it is preferable that the activation process is performed after forming the interlayer insulating film (an insulating film including silicon as its main component, for example a silicon nitride film) for the purpose of protecting the wirings and the like as in this embodiment mode.

And the hydrogenation can be performed by the heating process (at a temperature between 300° C. and 550° C. for 1 hour to 12 hours). This process is to terminate the dangling bond of the semiconductor layer with the hydrogen included in the first interlayer insulating film 461. The semiconductor layer can be hydrogenated whether or not the first interlayer insulating film exists.

Next, a second interlayer insulating film 462 is formed of an inorganic insulating material or an organic insulating material on the first interlayer insulating film 461. In this embodiment, an acrylic resin film is formed 1.6 μm in thickness. Not only the acrylic resin film but also another material can be employed provided that its viscosity is between 10 cp and 1000 cp, preferably between 40 cp to 200 cp, and that its surface can be made concave and convex.

In this embodiment, in order to prevent a direct reflection, a surface of a pixel electrode is made concave and convex by providing the second interlayer insulating film whose surface can be made concave and convex. In addition, in order to scatter the light by making the surface concave and convex, the convex portion may be formed in the region below the pixel electrode. In such a case, the convex portion can be formed with the same photomask as that when forming the TFT, and thereby the number of the processes does not need to be increased. It is noted that the convex portion may be provided in the pixel portion except for the wirings and TFT on the substrate. Concavity and convexity are thus formed on the surface of the pixel electrode along the concavity and convexity formed on the surface of the insulating film covering the convex portion.

Moreover, a film whose surface is plananized may be used as the second interlayer insulating film 462. In such a case, it is preferable that after forming the pixel electrodes, the surface is made concave and convex by adding the process such as the known sandblasting method, etching method or the like, to prevent the direct reflection and scatter the reflecting light in order to increase the degree of whiteness.

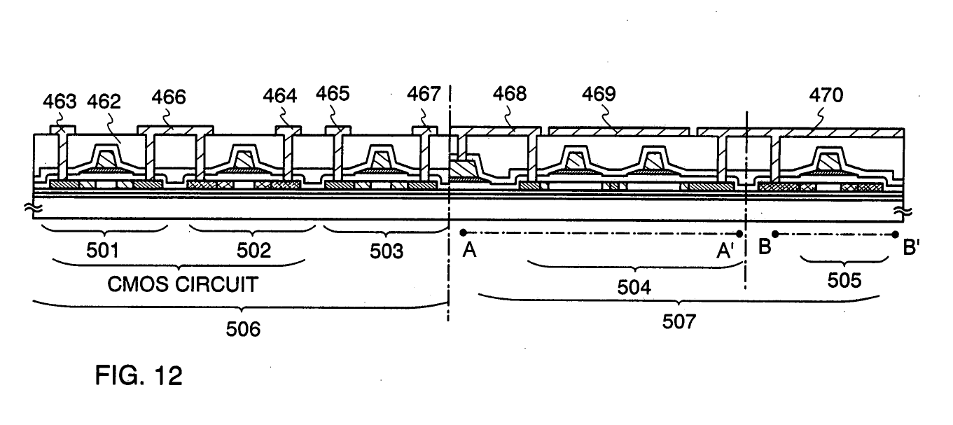

And in a driver circuit 506, wirings 464 to 468 connecting electrically each impurity region are formed. It is noted that these wirings are formed by patterning the laminated film of the Ti film having a thickness of 50 nm, and an alloy film (alloy film of Al and Ti) having a thickness of 500 nm. Of course, the film for the wirings may be formed not only in a two-layers structure, but also in a single-layer structure or a laminated-layer structure of three or more layers. The material for the wirings is not limited to Al and Ti. For example, the laminated film where Al or Cu is formed on the TaN film and a Ti film is further formed may be patterned to form the wirings (FIG. 12)

In the pixel portion 507, a pixel electrode 470, a gate wiring 469, and a connecting electrode 468 are formed. The connecting electrode 468 forms an electrical connection between the source wiring (the laminated layers of 443a and 443b) and the pixel TFT. In addition, the gate wiring 469 and the gate electrode of the pixel TFT are electrically connected. Moreover, the pixel electrode 470 is electrically connected with the drain region 442 of the pixel TFT and is further connected electrically with the semiconductor layer 458 working as one electrode forming the retention volume. In addition, it is preferable that the pixel electrode 471 is formed of the material with high reflectivity such as a film including Al or Ag as its main component or a laminated layer of the above film.

With these procedures, a driver circuit 506 having a CMOS circuit including n-channel TFT 501 and p-channel TFT 502, and a n-channel TFT 503, and a pixel portion 507 having a pixel TFT 504 and a retention volume 505 can be integrated on a same substrate. Thus an active matrix substrate is completed.

The n-channel TFT 501 included in the driver circuit 506 has a channel forming region 437, a low-concentrated impurity region 436 (GOLD region) overlapping with the first conductive layer 428a comprising a part of the gate electrode, a high-concentrated impurity region 452 functioning as a source region or a drain region, and an impurity region 451 doped impurity element that imparts n-type and impurity element that imparts p-type. The p-channel TFT 502 forming a CMOS circuit by connecting this n-channel TFT 501 with the electrode 466 has a channel forming region 440, a high-concentrated impurity region 454 functioning as a source region or a drain region, and a impurity region 453 doped impurity element that imparts n-type and impurity element that imparts p-type. Moreover, the n-channel TFT 503 has a channel forming region 443, a low-concentrated impurity region 442 (GOLD region) overlapping with the first conductive layer 430a comprising a part of the gate electrode, a high-concentrated impurity region 456 functioning as a source region or a drain region, and an impurity region 455 doped impurity element imparting n-type and impurity element that imparting p-type.

The pixel TFT 540 in the pixel portion has a channel forming region 446, a low-concentrated impurity region 445 (LDD region) formed outside of the gate electrode, a high-concentrated impurity region 458 functioning as a source region or a drain region, and an impurity region 457 doped impurity that imparts n-type and impurity that imparts p-type. And the semiconductor layer functioning as one electrode of the retention volume 505 is doped impurity that imparts n-type and impurity that imparts p-type. The retention volume 505 is formed of the electrode (the laminated layer of 432a and 432b) and the semiconductor layer, having the insulating film 416 as its dielectric.

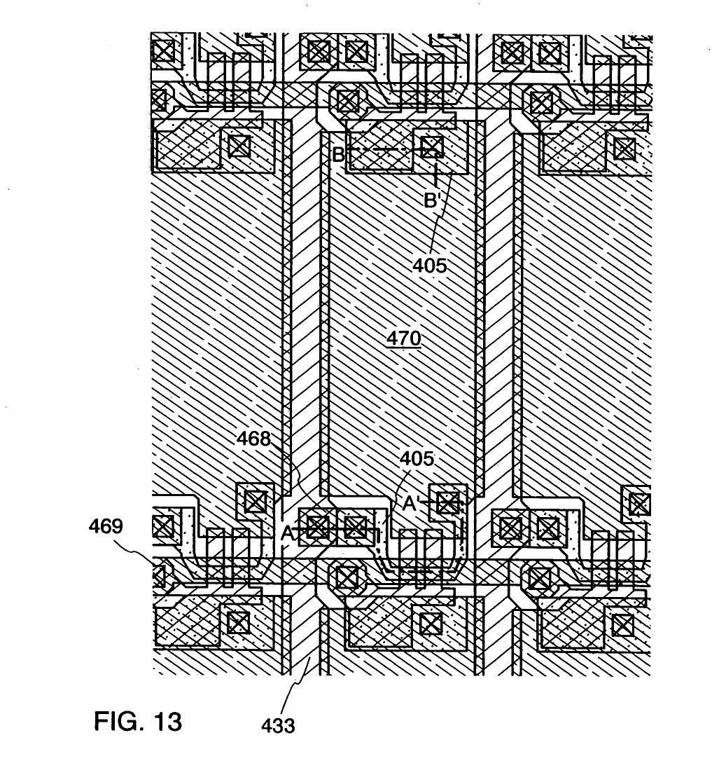

In addition, FIG. 13 is a top view of the pixel portion in the active matrix substrate manufactured in this embodiment. It is noted that the same reference number is used in the same part in FIG. 10A to 13. A dotted line A-A′ in FIG. 12 corresponds to a sectional view taken along a dotted line A-A′ in FIG. 13. Moreover, a dotted line B-B′ in FIG. 12 corresponds to a sectional view taken along a dotted line B-B′ in FIG. 13.

The liquid crystal display device thus manufactured has TFT including the semiconductor film whose characteristic is similar to that of single crystal, and the uniformity of the property of the semiconductor film is very high. Therefore, it is possible to ensure the high operating characteristic and reliability of the liquid crystal display device. In addition, since the linear laser beam which is homogenized in the direction of its major axis can be formed through the optical system, the crystalline semiconductor film with high uniformity can be obtained with this linear laser beam, which enables to reduce the variation of the electrical characteristic of TFT. Furthermore, since the length of the linear laser beam is changeable in accordance with the design rule of the TFT, throughput can be enhanced and the design rule can be also eased. And the operating characteristic and the reliability can be enhanced in the liquid crystal display device manufactured according to the present invention. In addition, unlike the conventional laser annealing method using a gas laser, the present invention enables to use a solid laser. Therefore, the cost for manufacturing the liquid crystal display device can be reduced. And such a liquid crystal display device can be employed in the display portion in the various electronic devices.

### Embodiment 2

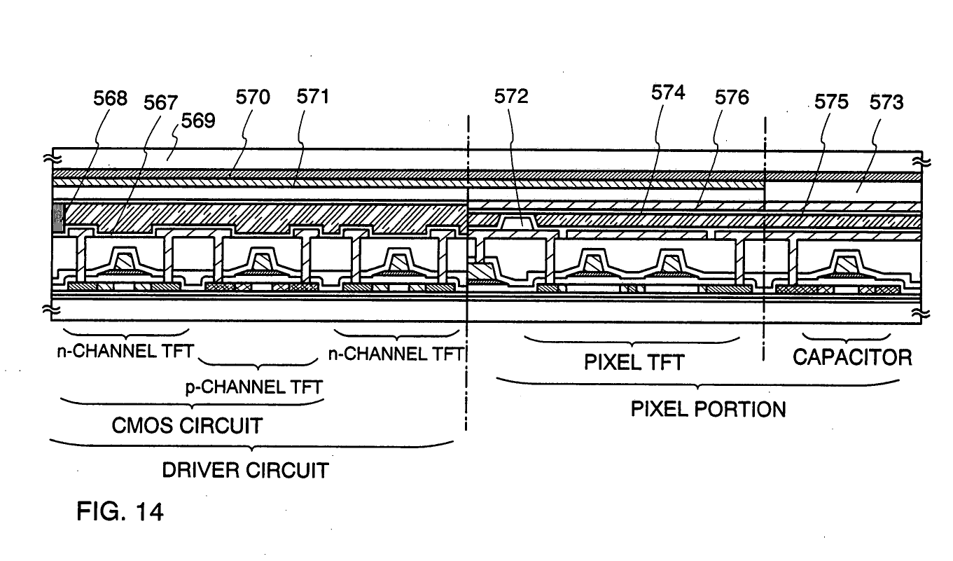

This embodiment explains a process to manufacture a liquid crystal display device of reflecting type out of the active matrix substrate manufactured in the embodiment 1. FIG. 14 is used for the explanation.

First of all, the active matrix substrate in a state shown in FIG. 12 is prepared according to the processes in the embodiment 1. Then an alignment film 567 is formed on the active matrix substrate in FIG. 12, at least on the pixel electrode 470, and is rubbed. It is noted that before forming the alignment film 567, a polar spacer 572 is formed in the desired position in order to keep enough spaces between the substrates by patterning the organic resin film such as the acrylic resin film or the like in this embodiment. Spherical spacer may be dispersed instead of the polar spacer.

Next, an opposing substrate 569 is prepared. Then a coloring layer 570, 571 and a planarizing film 573 are formed on the opposing substrate 569. The red coloring layer 570 and the blue coloring layer 571 are overlapped to form a light-shielding portion. In addition, the red coloring layer and the green coloring layer may be overlapped partially to form the light-shielding portion.

In this embodiment, the substrate shown in the embodiment 1 is used. Therefore, in FIG. 13 showing the top view of the pixel portion in the embodiment 1, it is necessary to shield the following spaces from the light; a space between the gate wiring 469 and the pixel electrode 470, a space between the gate wiring 469 and the connecting electrode 468, and a space between the connecting electrode 468 and the pixel electrode 470. In this embodiment, each coloring layer is arranged so that the light-shielding portions including the laminated coloring layers are overlapped on the position which should be shielded from the light as described above, and the opposing substrate is then pasted.

Thus it becomes possible to reduce the number of processes by shielding the spaces between each pixel from the light with the light-shielding portion including the coloring layers without forming the light-shielding layer such as a black mask.

Next, an opposing electrode 576 including a transparent conductive film is formed on the planarizing film 573, at least on the pixel portion, and then an alignment film 574 is formed on the whole surface of the opposing substrate and is rubbed.

And the active matrix substrate on which the pixel portions and the driver circuits are formed is pasted to the opposing substrate with sealing material 568. Filler is contained in the sealing material 568 and the two substrates are pasted while keeping a uniform space by this filler and the polar spacer. After that, liquid crystal material 575 is injected between the substrates and the two substrates are sealed with sealant (not shown in the figure) completely. The known liquid crystal material may be employed for the liquid crystal material 575. Thus the liquid crystal display device of reflection type is completed. And if necessary, the active matrix substrate and the opposing substrate are cut into a desired shape. Moreover, a polarization plate (not shown in the figure) is pasted only to the opposing substrate. And FPC is pasted with the known technique.

The liquid crystal display device thus manufactured has TFT including the semiconductor film whose characteristic is similar to that of single crystal, and the uniformity of the property of the semiconductor film is very high. Therefore, it is possible to ensure the high operating characteristic and reliability of the liquid crystal display device. In addition, since the linear laser beam which is homogenized in the direction of its major axis can be formed through the optical system, the crystalline semiconductor film with high uniformity can be obtained with this linear laser beam, which enables to reduce the variation of the electrical characteristic of TFT. Furthermore, since the length of the linear laser beam is changeable in accordance with the design rule of the TFT, throughput can be enhanced and the design rule can be also eased. And the operating characteristic and the reliability can be enhanced in the liquid crystal display device manufactured according to the present invention. In addition, unlike the conventional laser annealing method with a gas laser, the present invention can use a solid laser. Therefore, the cost for manufacturing the liquid crystal display device can be reduced. And such a liquid crystal display device can be employed in the display portion in the various electronic devices.

It is noted that this embodiment can be freely combined with any of embodiment mode 1 to 4.

### Embodiment 3

This embodiment explains an example in which the method for manufacturing TFT when manufacturing the active matrix substrate shown in the embodiment 1 is applied to manufacture a light-emitting device. In this specification, the light-emitting device is a generic term for a display panel where the light-emitting element formed on the substrate is included between the substrate and the cover member, and for a display module where the display panel is equipped with TFT. It is noted that the light-emitting element has a layer including an organic compound giving electroluminescence by applying electric field (light-emitting layer), a cathode layer and an anode layer. And the luminescence in the organic compound includes one or both of the luminescence (fluorescence) when returning from the singlet excited state to the ground state, and the luminescence (phosphorescence) when returning from the triplet excited state to the ground state.

It is noted that all the layers formed between the anode and the cathode in the light-emitting element are defined as the organic light-emitting layer. Specifically, the organic light-emitting layer includes the light-emitting layer, a hole injecting layer, an electron injecting layer, a hole transporting layer, an electron transporting layer and the like. Basically, the light-emitting element has a structure where an anode layer, a light-emitting layer, and the cathode layer are laminated in order. In addition to this structure, the light-emitting element may have a structure where an anode layer, a hole injecting layer, a light-emitting layer, and a cathode layer are laminated in order, or a structure where an anode layer, a hole injecting layer, a light-emitting layer, an electron transporting layer, a cathode layer and the like are laminated in order.

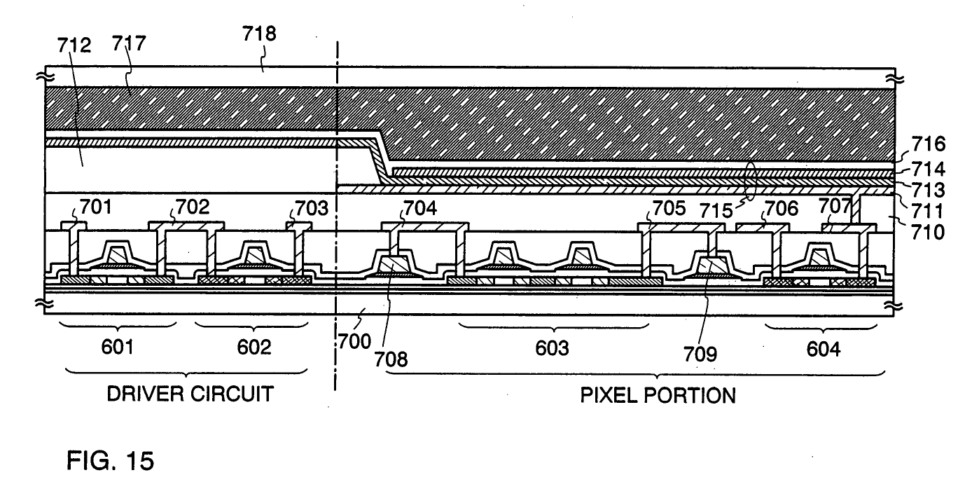

FIG. 15 is a sectional view of the light-emitting device in this embodiment. In FIG. 15, a switching TFT 603 provided on the substrate 700 is formed with n-channel TFT 503 in FIG. 12. Therefore, concerning the structure of the switching TFT 603, the explanation of the n-channel TFT 503 may be referred to.

The driver circuit provided on the substrate 700 is formed with the CMOS circuit in FIG. 12. Therefore, concerning the structure of the driver circuit, the explanation about the structure of the n-channel TFT 501 and p-channel TFT 502 may be referred to. It is noted that in this embodiment, its structure is single-gate structure, but double-gate structure or triple-gate structure may be also employed.

It is noted that the wiring 701 and 703 function as the source wiring of the CMOS circuit, and the wiring 702 functions as the drain wiring of the CMOS circuit. In addition, the wiring 704 functions as the wiring that electrically connects the source wiring 708 with the source region of the switching TFT. The wiring 705 functions as the wiring that connects electrically the drain wiring 709 and the drain region of the switching TFT.

It is noted that a current controlling TFT 604 is formed with the p-channel TFT 502 in FIG. 12. Therefore, concerning the structure of the current controlling TFT 604, the explanation of the p-channel TFT 502 may be referred to. It is noted that in this embodiment, it is formed in a single-gate structure, but may be formed in a double-gate or triple-gate structure, too.

The wiring 706 is the source wiring of the current controlling TFT (corresponding to the electric wiring) and a reference number 707 is an electrode that connects electrically with the pixel electrode 711 by overlapping on the pixel electrode 711 of the current controlling TFT.

It is noted that a reference number 711 is a pixel electrode (the anode of the light-emitting element) including the transparent conductive film. The transparent conductive film can be formed of a compound of indium oxide and tin oxide, a compound of indium oxide and zinc oxide, zinc oxide, tin oxide, or indium oxide. Moreover, the transparent conductive film added gallium may be employed. The pixel electrode 711 is formed on the plane interlayer insulating film 710 before forming those wirings. In this embodiment, it is very important to planarize the steps due to the TFT with the planarizing film 710 made from resin. This is because the light-emitting layer that is formed later is so thin that the faulty luminance might occur due to the steps. Therefore, it is preferable to planarize before forming the pixel electrode so that the light-emitting layer is formed on the plane as plane as possible.

After forming the wiring 701 to 707, a bank 712 is formed as shown in FIG. 15. The bank 712 is formed by patterning the insulating film including silicon, or the organic resin film, having a thickness of 100 nm to 400 nm.

It is noted that attention must be paid for the element when the film is formed so that the element may not be damaged due to electrostatic discharge because the bank 712 is insulative. In this embodiment, the resistivity is lowered by adding the carbon particle or the metal particle in the insulating film which turns to be the bank 712 so as to suppress the electrostatic. In such a case, the amount of the carbon particle and the metal particle is adjusted so that the: resistivity is 1×10⁶ Ωm to 1×10¹² Ωm (preferably 1×10⁸ Ωm to 1×10¹⁰ Ωm).

A light-emitting layer 713 is formed on the pixel electrode 711. It is noted that FIG. 15 shows only one pixel but in this embodiment the light-emitting layers are made in parts corresponding to each color of R (red); G (green) and B (blue). In addition, in this embodiment, low molecular weight organic light-emitting element is formed with the deposition method. Specifically, a copper phthalocyanine (CuPc) film having a thickness of 20 nm is formed as the hole injecting layer, and a tris-8-quinolinolato aluminum complex (Alq₃) film having a thickness of 70 nm is formed on it as the light-emitting layer. That is to say, these films are formed in a laminated structure. Adding the pigment such as quinacridone, perylene, DCM1 or the like to Alq3 can control the color.

However, the organic light-emitting materials available for the light-emitting layer are not limited to those described above at all. The light-emitting layer, the charge transporting layer, and the charge injecting layer are freely combined to form the light-emitting layer (the layer for luminescence and for moving the carrier for the luminescence). For example, this embodiment shows an example in which the low molecular weight organic light-emitting material is employed for the light-emitting layer, but the medium molecular weight organic light-emitting material or high molecular weight organic light-emitting material may be also utilized. It is noted that the medium molecular weight organic light-emitting material is defined as the organic light-emitting material with no sublimation whose molecule number is not more than 20, and whose length of the chained molecule is not more than 10 μm. And as an example of using the high molecular weight organic light-emitting material, a polythiophene (PEDOT) film is formed in 20 nm thick as the hole injecting layer with the spin coating method, and a para-phenylene vinylene (PPV) film having a thickness of 100 nm approximately is laminated as the light-emitting layer on it. It is noted that when π-conjugated polymer of PPV is employed, the wavelength can be selected ranging from red color to blue color. In addition, the inorganic material such as silicon carbide can be also used as the electron transporting layer and the electron injecting layer. The known material can be used for these organic light-emitting material and inorganic material.

Next, a cathode 714 including the conductive film is provided on the light-emitting layer 713. In case of this embodiment, an alloy film of aluminum and lithium is used as the conductive film. Of course, the known MgAg film (the alloy film of magnesium and silver) can be also used. A conductive film including the first or second element in the periodic table or a conductive film added these elements can be used as the cathode material.

When the processes are performed up to form the cathode 714, the light-emitting element 715 is completed. It is noted that the light-emitting element 715 described here indicates a diode formed of the pixel electrode. (anode) 711, the light-emitting layer 713 and the cathode 714.

It is effective to provide a passivation film 716 so as to cover the light-emitting element 715 completely. The passivation film 716 is formed of the insulating film including the carbon film, silicon nitride film, or silicon nitride oxide film, in a single-layer or laminated-layer structure.

Here, it is preferable to employ the film whose coverage is good as the passivation film, and it is effective to employ the carbon film, especially DLC film. The DLC film can be formed at a temperature ranging from the room temperature to 100° C. Therefore, it is easily formed over the light-emitting layer 713 whose resistance against heat is low. Moreover, the DLC film is superior in its blocking effect against oxygen, and it is possible to suppress oxidization of the light-emitting layer 713. Therefore, it can prevent the light-emitting layer 713 from oxidizing during the following sealing process.

Moreover, the sealant 717 is provided on the passivation film 716 to paste the cover member 718. A UV cure resin is used as the sealant 717 and it is effective to provide the absorbent material or antioxidant material inside. In addition, in this embodiment, the cover member 718 is a glass substrate, a quartz substrate, a plastic substrate (including plastic film), or a flexible substrate, that has carbon films (preferably DLC films) on both sides. Instead of the carbon film, the aluminum film (AlON, AlN, AlO or the like), SiN or the like can be used.

Thus the light-emitting device having the structure shown in FIG. 15 is completed. It is effective to perform continuously all the processes after forming the bank 712 up to form the passivation film 716 in the deposition system of multi-chamber type (or in-line type) without releasing them to the air. Furthermore, it is possible to have the further processes up to paste the cover member 718 performed continuously without releasing them to the air.

Thus, the n-channel TFT 601, 602, the switching TFT (n-channel TFT) 603, and the current controlling TFT (n-channel TFM) 604 are formed on the substrate 700.

In addition, as explained in FIG. 15, providing an impurity region overlapping on the gate electrode through the insulating film can form the n-channel TFT that has enough resistance against deterioration due to the hot-carrier effect. Therefore, the light-emitting device with high reliability can be realized.

Although this embodiment shows only the structure of the pixel portion and the driver circuit, another logical circuits such as a signal divider circuit, a D/A converter, an operational amplifier, γ correction circuit can be further formed on the same insulating substrate according to the manufacturing processes in this embodiment. Moreover, a memory and a microprocessor can be further formed.

The light-emitting device thus manufactured has TFT including the semiconductor film whose characteristic is similar to that of single crystal, and the uniformity of the property of the semiconductor film is very high. Therefore, it is possible to ensure the high operating characteristic and reliability of the light-emitting device. In addition, since the linear laser beam which is homogenized in the direction of its major axis can be formed through the optical system, the crystalline semiconductor film with high uniformity can be obtained with this linear laser beam, which enables to reduce the variation of the electrical characteristic of TFT. Furthermore, since the length of the linear laser beam is changeable in accordance with the design rule of the TFT, throughput can be enhanced and the design rule can be also eased. And the operating characteristic and the reliability can be enhanced in the light-emitting device manufactured according to the present invention. In addition, unlike the conventional laser annealing method with a gas laser, the present invention enables to use a solid laser. Therefore, the cost for manufacturing the light-emitting device can be reduced. And such a light-emitting device can be employed in the display portion in the various electronic devices.

It is noted that this embodiment can be freely combined with the embodiment mode 1 through 4.

### Embodiment 4

Various kinds of semiconductor devices (liquid crystal display device of active matrix type, light-emitting device of active matrix type, and light-emitting display device of active matrix type) can be manufactured with the present invention. In other words, the present invention can be applied to various electronic devices having these electronic optical devices in their display portions.

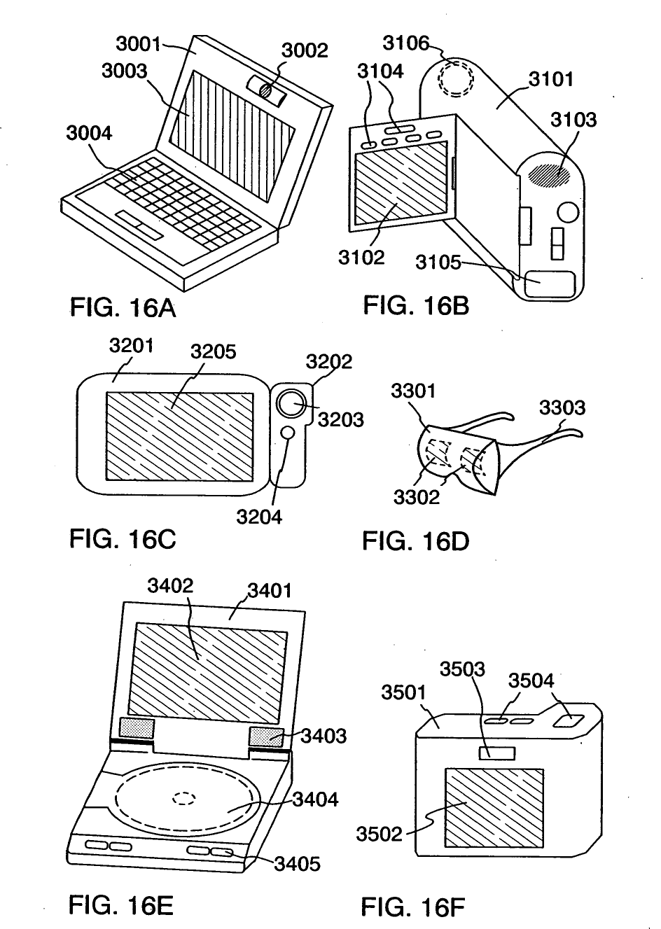

As the examples of such electronic devices, a video camera, digital camera, projector, head mounted display (goggle type display), car navigation, car stereo, personal computer, personal digital assistant (such as a mobile computer, cellular phone, electronic book, and the like) and the like are given. These examples are shown in FIG. 16A to 18C.

FIG. 16A shows a personal computer, including a main body 3001, an image reader 3002, a display portion 3003, a key board 3004, and the like. By employing the semiconductor device manufactured according to the present invention for the display portion 3003, the personal computer of the present invention is completed.

FIG. 16B shows a video camera, including a main body 3101, a display portion 3102, a voice input portion 3103, an operating switch 3104, a battery 3105, an image receiver 3106, and the like. By employing the semiconductor device manufactured according to the present invention for the display portion 3102, the video camera of the present invention is completed.

FIG. 16C shows a mobile computer, including a main body 3201, a camera portion 3202, an image receiver 3203, an operating switch 3204, a display portion 3205 and the like. By employing the semiconductor device manufactured according to the present invention for the display portion 3205, the mobile computer of the present invention is completed.

FIG. 16D shows a goggle type display, including a main body 3301, a display portion 3302, an arm portion 3303 and the like. The display portion 3302 includes a flexible substrate which is inflected to manufacture the goggle type display. In addition, the goggle type display can be made lightweight and thin. By employing the semiconductor device manufactured according to the present invention for the display portion 3302, the goggle type display of the present invention is completed.

FIG. 16E shows a player utilizing a recording medium that has a program recorded (hereinafter referred to as a recording medium) including a main body 3401, a display portion 3402, a speaker portion 3403, a recording medium 3404, an operating switch 3405 and the like. It is noted that this player enables to enjoy listening to the music, watching the movies, playing the game, and playing on the Internet using a DVD (Digital Versatile Disc), CD or the like as its recording medium. By employing the semiconductor device manufactured according to the present invention for the display portion 3402, the recording medium of the present invention is completed.

FIG. 16F shows a digital camera, including a main body 3501, a display portion 3502, an eye piece 3503, an operating switch 3504, an image receiver (not shown in the figure) and the like. By employing the semiconductor device manufactured according to the present invention for the display portion 3502, the digital camera of the present invention is completed.

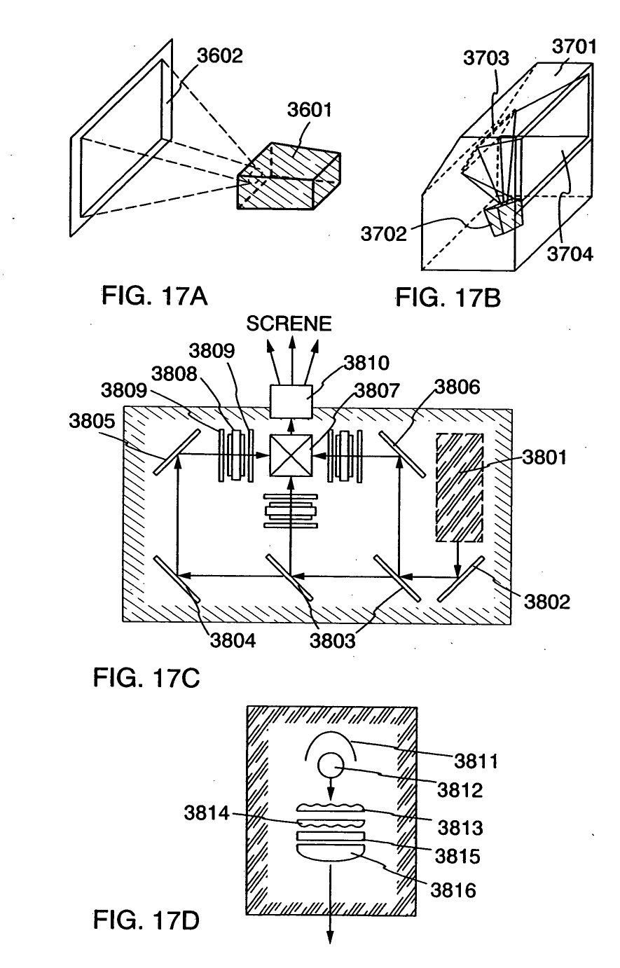

FIG. 17A shows a front projector, including a projection device 3601, a screen 3602, and the like. By employing the semiconductor device manufactured according to the present invention for the liquid crystal display device 3808 comprising a part of the projection device 3601, and other driver circuits, the front projector of the present invention is completed.

FIG. 17B shows a rear projector, including a main body 3701, a projection device 3702, a mirror 3703, a screen 3704 and the like. By employing the semiconductor device manufactured according to the present invention for the liquid crystal display device 3808 comprising a part of the projection device 3702, and other circuits, the rear projector of the present invention is completed.

It is noted that FIG. 17C is a figure indicating an example of the structure of the projection device 3601 in FIG. 17A and 3702 in FIG. 17B. The projection device 3601 and 3702 includes an optical system of light source 3801, mirrors 3802, 3804 to 3806, a dichroic mirrors 3803, a prism 3807, a liquid crystal display device 3808, a wave plate 3809, and a projection optical system 3810. The projection optical system 3810 has an optical system including a projection lens. This example showed the projection device of three-plate type, but there is no limitation on this, and the projection device of single-plate type is also acceptable. Moreover, the practitioner may arrange the optical lens, a film having a deflecting function, a film for adjusting phase contrast, an IR film or the like in the optical path shown by an arrow in FIG. 17C.

Moreover, FIG. 17D shows an example of the structure of the optical system of light source 3801 including a reflector 3811, a light source 3812, lens arrays 3813, 3814, a polarization changing element 3815, and a condensing lens 3816. It is noted that the optical system of light source is just one example, and is not limited to that described above. For example, the practitioner may provide an optical lens, a film having a polarizing function, a film for adjusting phase contrast, an IR film or the like in the optical system appropriately.

However, FIG. 17A, 17B and 17C show the projectors utilizing a transmission electronic optical device, and do not show the examples of another application utilizing reflection electronic optical device and light-emitting device.

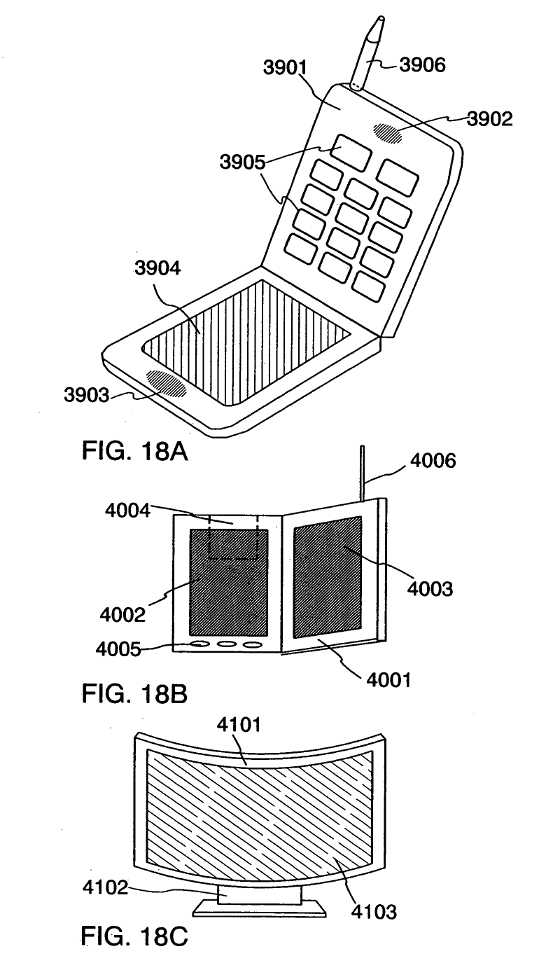

FIG. 18A shows a cellular phone, including a main body 3901, a voice output portion 3902, a voice input portion 3903, a display portion 3904, an operating switch 3905, an antenna 3906 and the like. By employing the semiconductor device manufactured according to the present invention for the display portion 3904, the cellular phone of the present invention is completed.

FIG. 18B shows a mobile book (electronic book), including a main body 4001, display portions 4002 and 4003, a recording medium 4004, an operating switch 4005, an antenna 4006 and the like. By employing the semiconductor device manufactured according to the present invention for the display portions 4002 and 4003, the mobile book (electronic book) of the present invention is completed. Moreover, the mobile book (electronic book) can be made as small as the pocketbook, which makes it easier to carry.

FIG. 18C shows a display, including a main body 4101, a supporting stand 4102, a display portion 4103 and the like. The display portion 4103 is manufactured with a flexible substrate, and thereby the light and thin display can be realized. Moreover, it is possible to inflect the display portion 4103. By employing the semiconductor device manufactured according to the present invention for the display portion 4103, the display of the, present invention is completed. The present invention is advantageous especially in manufacturing a large-sized display having a length of 10 inch or more (especially more than 30 inch) diagonally.

The display device thus manufactured has TFT manufactured with the semiconductor film whose characteristic is similar to that of single crystal, and the uniformity of the property of the semiconductor film is very high. Therefore, it is possible to ensure the high operating characteristic and reliability of the light-emitting device. In addition, since the linear laser beam which is homogenized in the direction of its major axis can be formed through the optical system, the crystalline semiconductor film with high uniformity can be obtained with this linear laser beam, which enables to reduce the variation of the electrical characteristic of TFT. Furthermore, since the length of the linear laser beam is changeable in accordance with the design rule of the TFT, throughput can be enhanced and the design rule can be also eased. And the operating characteristic and the reliability can be enhanced in the display device manufactured according to the present invention. In addition, unlike the conventional laser annealing method with a gas laser, the present invention enables to use a solid laser. Therefore, the cost for manufacturing the display device can be reduced. And such a display device can be employed in the display portion in the various electronic devices.

The present invention can be widely applied to the various kinds of electronic devices. It is noted that these electronic devices described in this embodiment can be manufactured with the structure combining any of the embodiment modes 1 to 4 and the embodiment 1, 2, or combining any of the embodiment modes 1 to 4 and the embodiment 1, 3.

1. A laser irradiation method comprising the steps of[[;]]:
changing a first laser beam into a second laser beam with uniform energy distribution through a first optical system;
shaping the second laser beam into a linear laser beam with uniform energy distribution by having the second laser beam form an image on a surface to be irradiated through a second optical system having a zoom function[[,]]; and
changing a size of the linear laser beam on the surface to be irradiated by operating the zoom function appropriately.

2. A laser irradiation method comprising the steps of[[;]]:
changing a first laser beam into a second laser beam with uniform energy distribution through a diffractive optics[[,]];
shaping the second laser beam into a linear laser beam with uniform energy distribution by having the second laser beam form an image on a surface to be irradiated through an optical system having a zoom function[[,]]; and
changing a size of the linear laser beam on the surface to be irradiated by operating the zoom function appropriately.

3. A laser irradiation method comprising the steps off[;]]:
changing a first laser beam into a second laser beam with uniform energy distribution through a first optical system[[,]]; and
shaping the second laser beam into a linear laser beam with uniform energy distribution by having the second laser beam form an image on a surface to be irradiated through a second optical system having a finite conjugate design.

4. A laser irradiation method comprising the steps of [[;]]:
changing a first laser beam into a second laser beam with uniform energy distribution through [[a]] diffractive optics[[,]]; and
shaping the second laser beam into a linear laser beam with uniform energy distribution by having the second laser beam form an image on a surface to be irradiated through an optical system having a finite conjugate design.

5. A laser irradiation method comprising the steps of[[;]]:
changing a first laser beam into a second laser beam with uniform energy distribution through a first optical system[[,]];
shaping the second laser beam into a linear laser beam with uniform energy distribution by having the second laser beam form an image on a surface to be irradiated through a second optical system having a finite conjugate design[[,]]; and
changing a size of the linear laser beam on the surface to be irradiated by changing a ratio of the finite conjugate design.

6. A laser irradiation method comprising the steps of[[;]]:
changing a first laser beam into a second laser beam with uniform energy distribution through a diffractive optics[[,]];
shaping the second laser beam into a linear laser beam with uniform energy distribution by having the second laser beam form an image on a surface to be irradiated through an optical system having a finite conjugate design[[,]]; and
changing a size of the linear laser beam on the surface to be irradiated by changing a ratio of the finite conjugate design.

7. A laser irradiation method according to claim 1, wherein the laser beam is emitted from a laser oscillator selected from the group consisting of a gas laser, a solid laser, and a metal laser.

8. A laser irradiation method according to claim 1, wherein the laser beam is emitted from a laser oscillator selected from the group consisting of an Ar laser, a Kr laser, a CO₂ laser, a YAG laser, a YVO₄ laser, a YLF laser, a YAlO₃ laser, a Y₂O₃ laser, an alexandrite laser, a Ti: sapphire laser and a helium-cadmium laser.

9. A laser irradiation apparatus comprising:
a laser oscillator;
a first optical system changing a first laser beam emitted from the laser oscillator into a second laser beam with uniform energy distribution; and
a second optical system having a zoom function forming an image on a surface to be irradiated with the second laser beam and changing a size of the second laser beam on the surface to be irradiated.

10. A laser irradiation apparatus comprising:
a first laser oscillator;
[[a]] diffractive optics changing a laser beam emitted from the laser oscillator into a second laser beam with uniform energy distribution; and
an optical system having a zoom function forming an image with the second laser beam on a surface to be irradiated and changing a size of the second laser beam on the surface to be irradiated.

11. A laser irradiation apparatus comprising:
a first laser oscillator;
a first optical system changing a laser beam emitted from the laser oscillator into a second laser beam with uniform energy distribution; and
a second optical system having a finite conjugate design forming an image with the second laser beam on a surface to be irradiated.

12. A laser irradiation apparatus comprising:
a first laser oscillator;
[[a]] diffractive optics changing a laser beam emitted from the laser oscillator into a second laser beam with uniform energy distribution; and
an optical system having a finite conjugate design forming an image with the second laser beam on a surface to be irradiated.

13. A laser irradiation apparatus comprising:
a first laser oscillator;
a first optical system changing a laser beam emitted from the laser oscillator into a second laser beam with uniform energy distribution; and
a second optical system having a finite conjugate design forming an image with the second laser beam on a surface to be irradiated and changing a size of the second laser beam on the surface to be irradiated.

14. A laser irradiation apparatus comprising:
a first laser oscillator;
[[a]] diffractive optics changing a laser beam emitted from the laser oscillator into a second laser beam with uniform energy distribution[[,]]; and
an optical system having a finite conjugate design forming an image with the second laser beam on a surface to be irradiated and changing a size of the second laser beam on the surface to be irradiated.

15. A laser irradiation apparatus according to claim 9, wherein the laser beam is emitted from a laser oscillator selected from the group consisting of a gas laser, a solid laser, and a metal laser.

16. A laser irradiation apparatus according to claim 9, wherein the laser beam is emitted from a laser oscillator selected from the group consisting of an Ar laser, a Kr laser, a CO₂ laser, a YAG laser, a YVO₄ laser, a YLF laser, a YAlO₃ laser, a Y₂O₃ laser, an alexandrite laser, a Ti: sapphire laser and a helium-cadmium laser.

17. A method for manufacturing a semiconductor device, wherein a laser beam emitted from a laser oscillator is changed into a linear laser beam on a semiconductor film or its vicinity, comprising the steps of:
changing a first laser beam into a second laser beam with uniform energy distribution through a first optical system;
shaping the second laser beam into linear by having the second laser beam form an image on a surface to be irradiated through a second optical system having a zoom function; and
changing a size of the linear laser beam on the surface to be irradiated in accordance with an arrangement of a semiconductor film by operating the zoom function appropriately.

18. A method for manufacturing a semiconductor device, wherein a laser beam emitted from a laser oscillator is changed into a linear laser beam on a semiconductor film or its vicinity, comprising the steps of:
changing a first laser beam into a second laser beam with uniform energy distribution through [[a]] diffractive optics;
shaping the second laser beam into linear by having the second laser beam form an image on a surface to be irradiated through an optical system having a zoom function; and
changing a size of the linear laser beam on the surface to be irradiated in accordance with an arrangement of a semiconductor film by operating the zoom function appropriately.

19. A method for manufacturing a semiconductor device, wherein a laser beam emitted from a laser oscillator is changed into a linear laser beam on a semiconductor film or its vicinity, comprising the steps of:
changing a first laser beam into a second laser beam with uniform energy distribution through a first optical system;
shaping the second laser beam into linear by having the second laser beam form an image on a surface to be irradiated through a second optical system having a finite conjugate design; and
irradiating the linear laser beam to the semiconductor film.

20. A method for manufacturing a semiconductor device, wherein a laser beam emitted from a laser oscillator is changed into a linear laser beam on a semiconductor film or its vicinity, comprising the steps of:
changing a first laser beam into a second laser beam with uniform energy distribution through [[a]] diffractive optics;
shaping the second laser beam into linear by having the second laser beam form an image on a surface to be irradiated through an optical system having a finite conjugate design; and
irradiating the linear laser beam to the semiconductor film.

21. A method for manufacturing a semiconductor device, wherein a laser beam emitted from a laser oscillator is changed into a linear laser beam on a semiconductor film or its vicinity, comprising the steps of:
changing a first laser beam into a second laser beam with uniform energy distribution through a first optical system;
shaping the second laser beam into linear by having the second laser beam form an image on a surface to be irradiated through a second optical system having a finite conjugate design; and
changing a size of the linear laser beam by changing a ratio of the finite conjugate design in accordance with an arrangement of a semiconductor film.

22. A method for manufacturing a semiconductor device, wherein a laser beam emitted from a laser oscillator is changed into a linear laser beam on a semiconductor film or its vicinity, comprising the steps of:
changing a first laser beam into a second laser beam with uniform energy distribution through [[a]] diffractive optics;
shaping the second laser beam into linear by having the second laser beam form an image on a surface to be irradiated through an optical system having a finite conjugate design; and
changing a size of the linear laser beam on the surface to be irradiated by changing a ratio of the finite conjugate design in accordance with an arrangement of a semiconductor film.

23. A method for manufacturing a semiconductor device according to claim 17, wherein the laser beam is emitted from a laser oscillator selected from the group consisting of a gas laser, a solid laser, and a metal laser.

24. A method for manufacturing a semiconductor device according to claim 17, wherein the laser beam is emitted from a laser oscillator selected from the group consisting of an Ar laser, a Kr laser, a CO₂ laser, a YAG laser, a YVO₄ laser, a YLF laser, a YAlO₃ laser, a Y₂O₃ laser, an alexandrite laser, a Ti: sapphire laser and a helium-cadmium laser.

25. A method of manufacturing a semiconductor device comprising:
forming a semiconductor film over a substrate; and
irradiating said semiconductor film with a pulsed laser beam to crystallize said semiconductor film,
wherein a frequency of said pulsed laser beam is 1 MHz or larger.

26. The method according [[of]] to claim 25, wherein said frequency is within a range of 1 MHz to 1 GHz.

27. The method according to claim 26, wherein said pulsed laser beam is a second harmonic of YVO₄ laser.

28. A method of manufacturing a semiconductor device comprising:
forming a semiconductor film over a substrate;
providing said semiconductor film with a material comprising a metal for promoting crystallization;
heating said semiconductor film to crystallize said semiconductor film; and
irradiating the crystallized semiconductor film with a pulsed laser beam to increase crystallinity of said semiconductor film,
wherein a frequency of said pulsed laser beam is 1 MHz or larger.

29. The method according [[of]] to claim 28 wherein said frequency is within a range of 1 MHz to 1 GHz.

30. The method according to claim 28 wherein said pulsed laser beam is a second harmonic of YVO₄ laser.

31. The method according to claim 28 wherein said metal is selected from the group consisting of nickel, palladium and lead.

32. A method for manufacturing a semiconductor device, wherein a pulse laser beam emitted from a pulse laser oscillator is changed into a linear pulse laser beam on a semiconductor film or its vicinity, comprising the steps of:
changing a first pulse laser beam into a second pulse laser beam with uniform energy distribution through a first optical system;
shaping the second pulse laser beam into linear by having the second pulse laser beam form an image on a surface to be irradiated through a second optical system having a zoom function; and
changing a size of the linear pulse laser beam on the surface to be irradiated in accordance with an arrangement of a semiconductor film by operating the zoom function appropriately,
wherein[[:]] the linear pulse laser is simultaneously irradiated together with a CW laser beam on the semiconductor film[[.]], and wherein the linear pulse laser is irradiated with another CW laser beam at the same time on the semiconductor film.

33. A method for manufacturing a semiconductor device according to claim 32, wherein the first pulse laser is a second harmonic of YVO₄ laser.

34. A method for manufacturing a semiconductor device, wherein a pulse laser beam emitted from a pulse laser oscillator is changed into a linear pulse laser beam on a semiconductor film or its vicinity, comprising the steps of:
changing a first pulse laser beam into a second pulse laser beam with uniform energy distribution through a first optical system;
shaping the second pulse laser beam into linear by having the second pulse laser beam form an image on a surface to be irradiated through a second optical system having a zoom function;
changing a size of the linear pulse laser beam on the surface to be irradiated in accordance with an arrangement of a semiconductor film by operating the zoom function appropriately;
providing said semiconductor film with a material comprising a metal for promoting crystallization; and
heating said semiconductor film to crystallize said semiconductor film[[;]],
wherein[[:]] the linear pulse laser is simultaneously irradiated together with a CW laser beam on the semiconductor film.

35. A method for manufacturing a semiconductor device according to claim 34, wherein the first pulse laser is a second harmonic of YVO₄ laser.

36. A method for manufacturing a semiconductor device according to claim 28, wherein the metal element is nickel.

37. A method according to claim 1, wherein the second laser beam is a rectangular laser beam.

38. A method according to claim 1, wherein the second laser beam is an elliptical laser beam.

39. [[A]] An apparatus according to claim 9, wherein the second laser beam is a rectangular laser beam.

40. [[A]] An apparatus according to claim 9, wherein the second laser beam is an elliptical laser beam.
